(19) United States
(12) Patent Application Publication
(10) Pub. No.: US 2010/0182236 A1
(43) Pub. Date: Jul. 22, 2010

(54) COMPACT RTD INSTRUMENT PANELS AND COMPUTER INTERFACES

(76) Inventor: Timothy Pryor, Windsor (CA)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 12/748,665

(22) Filed: Mar. 29, 2010

Related U.S. Application Data
(63) Continuation of application No. 11/852,690, filed on Sep. 10, 2007.
Application No. 11/852,690 is a continuation-in-part of application No. 11/832,134, filed on Aug. 1, 2007.
Application No. 11/832,134 is a continuation-in-part of application No. 11/349,350, filed on Feb. 8, 2006.
Application No. 11/349,350 is a continuation-in-part of application No. 11/319,807, filed on Dec. 29, 2005, now Pat. No. 7,671,851.
Application No. 11/319,807 is a continuation-in-part of application No. 11/045,131, filed on Jan. 31, 2005.
Application No. 11/045,131 is a continuation-in-part of application No. 10/934,762, filed on Sep. 7, 2004.
Application No. 10/934,762 is a continuation-in-part of application No. PCT/US04/09701, filed on Mar. 31, 2004.
Application No. PCT/US04/09701 is a continuation-in-part of application No. 10/611,814, filed on Jul. 2, 2003, now Pat. No. 7,489,303.
Application No. 10/611,814 is a continuation-in-part of application No. 09/789,538, filed on Feb. 22, 2001, now Pat. No. 7,084,859.
(60) Provisional application No. 60/844,082, filed on Sep. 13, 2006.

(51) Int. Cl. G09G 5/08

(52) U.S. Cl. 345/158

(57) ABSTRACT

This concerns my RTD invention disclosed in co pending applications, particularly but not necessarily for use in the “center stack” region of vehicle instrument panels. Disclosed are novel prism devices to shrink the size of the unit, while increasing resistance to vibration and condensation and providing easier assembly into the vehicle. Also disclosed are methods to improve the efficiency of such projector based systems for delivering display light to the driver of the vehicle, as well as to reduce noise caused by backscatter from the screen and control surface, or sunlight coming through the windshield. RTD versions for home or office use are also disclosed, including a “cushion computer”-like device meant primarily for use on one's lap and optionally having a reconfigurable keyboard. The device can also serve as a TV remote and perform other useful functions in the home, workplace, or car, and may serve as a useful interface accessory to expand the usability and enjoyment of mobile devices.

This application is a continuation of U.S. patent application Ser. No. 11/852,690, filed Sep. 10, 2007 (now U.S. Pat. No. ______), which claims the benefit of U.S. Provisional Application 60/844,082, filed Sep. 13, 2006, and which is a continuation-in-part of U.S. patent application Ser. No. 11/832,134 (now U.S. Pat. No. ______), filed Aug. 1, 2007, U.S. patent application Ser. No. 11/349,350 (now U.S. Pat. No. ______), filed Feb. 8, 2006, U.S. patent application Ser. No. 11/319,807 (now U.S. Pat. No. 7,671,851), filed Dec. 29, 2005, U.S. patent application Ser. No. 11/184,076 (now U.S. Pat. No. 7,466,843), filed Jul. 19, 2005, U.S. patent application Ser. No. 11/045,131 (now U.S. Pat. No. ______), filed Jan. 31, 2005, PCT/US04/09701, filed Mar. 31, 2004, U.S. patent application Ser. No. 10/934,762 (now U.S. Pat. No. ______), filed Sep. 7, 2004, U.S. patent application Ser. No. 10/611,814 (now U.S. Pat. No. 7,489,303), filed Jul. 2, 2003, and U.S. patent application Ser. No. 09/789,538 (now U.S. Pat. No. 7,084,859), filed Feb. 22, 2001. The disclosures of the above patent applications are hereby incorporated by reference in their entirety.

### FIELD OF THE INVENTION

The invention is generally in the field of instrument panels for vehicles, and control and display devices for general. Disclosed are improvements and alternative embodiments of my RTD (Reconfigurable Tactile Display) invention disclosed in co pending applications, particularly relating to novel video projection and optical arrangements for both display and sensing of control inputs. Some embodiments may utilize the device for only sensing or only projection, but typically one wishes to both project and sense, either finger touch location, or physical control positions or states—any or all. The invention further concerns human interfaces for computing and display devices which can be conveniently used on ones lap for inputs to computers, control of audio and video devices, and the like. These interfaces may use their own computing resources, those of a remotely located computer, or those of an associated smart phone or other mobile device such as a PDA. A video projector of a smart phone may optionally be used to optically power the invention as well.

### BACKGROUND OF THE INVENTION

This application particularly concerns rear projection based systems for sensing and display in the center portion of vehicle instrument panels, called the “Center Stack”. When one looks at the prior rear projection art, it becomes quickly apparent that large flat screen home TV market, is where the vast majority of technical activity has taken place. Some useful references on rear projection television arrangements are described by; U.S. Pat. No. 6,896,375 Peterson and Gohman, 20030072077 Peterson et al, and 20040141157 Ramachandran and Prior. These TV prior art patents are incorporated herein by reference, as are all of my co pending applications and granted patents.

The vehicle application is considerably different than the TV application in that in general, it requires a considerably smaller screen curved in at least one plane, often two planes, and perhaps even curved sharply at the edges as well. In addition the ambient conditions are far more severe than home TV, exhibition or store display situation where the prior art lies. Additional variables include vibration, condensation, and temperature extremes. In addition there can be huge amounts of ambient light, also dynamically variable, in certain sunlit conditions. No known prior art discloses electro-optical sensing of physical control locations and finger touch location using video or still image projection based systems such as the “RTD” invention I have disclosed in co pending applications and which is the primary subject of this disclosure.

In promoting my invention, which has many desirable features, the questions most frequently raised are:

Depth into the dashboard. The maximum depth available in today's vehicles is about 6 inches, though many would prefer 4 or even 2 inches. This degree of slimness may not be needed all along the height and width of the center stack however, and is largely solved by this invention and other co pending applications. I feel that any extra depth required over and above 2 inches, can be tolerated especially in view of the advantages gained.

Brightness and contrast, especially on sunny days. This is aided by the invention regarding the efficiency of getting available projection light to the eye of the user and in blocking or absorbing incident sunlight. The invention indeed in the final analysis may be superior to other types of displays in terms of visibility.

Bulb life. The invention can use LED and diode laser sources, which effectively provide infinite life for most vehicular applications.

Vibration is effectively solved by this invention in its prism form, and other aspects of this and co pending applications.

Condensation on the optical components. The invention herein substantially solves this problem. The prism embodiments herein have no more optical surfaces necessarily than existing LCD screens that have been successfully employed in vehicle center stacks.

Cost. This has now been solved I feel. The projector, and particularly a laser scanning type, is proposed at very affordable prices and will likely have the brightness needed in the future. Addition of the sensing capability to it seems straightforward and very low cost. And all the rest of the components are moulded plastic. The prism, the screen and control surface, the knobs, the switches, everything.

Another important issue, providing a large display area while retaining easy to use controls and functions has been solved my RTD invention.

For vehicle center stack controls application, the invention described herein however largely applies to curved display surfaces that also function as control input devices for touch location or physical control locations. The total display area is of relatively small size by home TV standards, typically 10″.times.14″ or less, occupying up to the entire center stack region of the car instrument panel. The driver and right front seat passenger are typically seated close to the display, typically on the order of 20-25 inches away. Thus the size of displayed pixels on the screen typically needs to be less than that of an HDTV observed from a distance, at least for the same types of images. Some of the most important images displayed in the car however are simply labels and not high-resolution video. On the other hand the images of labels are static, and cannot have disturbing oscillation or other excessive time varying properties.

In another application area, the invention herein provides a user interface to computers (generally somewhat larger than the center stack example above, but not necessarily so) which can be used in the home, car, office and other locations. In one embodiment it has onboard computing resources, while in another it utilizes a remotely located computer, for example in the home, or in the car center stack. In a third example it uses the computer of a smart cell phone which may dock in the interface of the invention and optionally also contain the projector and sensor unit to display and sense information on the screen and control surface of the invention.

### SUMMARY OF THE INVENTION

This document contains further disclosure on my RTD (Reconfigurable Tactile Display) invention preferably (but not necessarily) employing a flying spot scanner based projector design, further incorporating a sensor of touch position on a surface as well as a sensor of knob and other physical control position or state, when said physical controls are on a surface (herein called the control surface) viewed by the projector/sensor unit While the most value is when the projector operates also as a sensor, many of the ideas herein may also apply to when an embodiment is operated only as sensor, or only as a projector.

The invention herein is particularly concerned with optical arrangements for the RTD and in particular prism based or mirror based optical systems which are optimized for the automotive center stack application in terms of small size (particularly in the depth direction), brightness and cost, as well as offering improved performance relative to problems encountered in the automotive environment, such as vibration, condensation (on optical elements) and ease of assembly and manufacture. The prism of the invention typically has one or more faces which are coated to reflect light inside the prism, although total internal reflection can be used where feasible and desirable.

A further portion of the invention relates to miniature systems that can be easily installed in the aftermarket in double din sized radio slots in the dashboard, or used as modules for portable devices.

The new Microvision or Symbol Technologies miniature projectors shown at the SID conference in San Francisco in June 2006 use three semiconductor laser sources (RGB), and as disclosed in some of my applications, these can also be effectively used to sense positions on the control surface of the RTD device, by adding a fast photo-detector and optionally a IR laser, as well as miscellaneous optics and electronics. These enable many new applications of the RTD to be effectively commercialized, especially since costs of such projectors are indicated to be as low as 100 dollars retail, and small enough to be packaged into a cell phone.

In addition to size, shape and purpose, the display of the invention herein also differs in many other regards from the usual TV application that is the subject of virtually all the prior art I can find. In one example, the projection device is a laser scanning type for example, which also functions in another mode as the sensor device for control inputs. Other image engine projection technology such as DLP or LCD may be used alternatively which may or may not be also combined with a sensing capability either external or internal, as has been shown in co pending applications.

The display of the invention is primarily used for the driver, and secondarily for the passengers of the vehicle, particularly the right front seat passenger who on occasion operates controls in the center stack. As such it is desirable to display light based information directed at them in order to improve the overall efficiency in utilizing the projector, resulting in a distribution of light from the screen which may be skewed toward certain angles, and/or asymmetrically presented, and entirely different than that of a projection TV. Some areas are purposely not illuminated where possible such as toward the floor, or toward the windshield where disturbing reflections can occur.

Because display of image data is most used in the top of the center stack this region may be constructed according to the invention to have more resolution and/or more brightness than the lower region. This is also because the ambient light striking the screen is much more intense at the top, especially sun coming down through the windshield. This brightness can even be locally controlled to increase in sun-drenched conditions for example.

As noted the design of the screen, if optical or other touch sensing is employed, has to facilitate this sensing.

Because most center stacks are somewhat narrower at the bottom than at the top (due to accommodating the right leg of the driver and the left leg of the passenger), some degree of keystone distortion can be tolerated (smaller at bottom than top) which would not be allowable in a TV. In the same vein, since in many cases there is no relationship between data projected at the top, and at the bottom, there can be variations between them, due to distortion or other factors. And there can even be local variations in these areas where just labels are being projected for example, as opposed to contiguous images. Conversely, because the surface of the center stack is generally curved, it is desirably to electronically compensate distortion caused not only by the optics as described in 20040141157 Ramachandran and Pryor, but by the shape of the generally curved an angled screen itself.

Because the car has severe regimens of vibration and condensation compared to a home TV, several prism based embodiments are also disclosed which help mitigate these problems. If desired, these prism units can be mounted as a unitary module into the vehicle with screen and projector rigidly attached.

Another application of the invention is for lap use by persons at home or in their car, or in bed such as a hospital bed or bed at home. This makes use of interchangeable screens and control surfaces (generally flat or nearly so) and weight saving and foam protected construction which also result in a device that is easier, safer, and more user friendly in every way than a typical laptop computer with which it might in some respects be compared. This device may have a somewhat larger display area of 17-21 inch diagonal if desired, which still can be comfortably accommodated on ones lap or on the back of a car seat in front of the user. In this application computing is preferably (but not necessarily) remote to the lap located “cushion computer” or seatback device in order to save weight, increase safety in event of accidents, and make the device more able to absorb spills and drops, while decreasing electrical shock hazards. Other locations can be contemplated as well such as on office desks; countertops in kitchens, walls and sitting next to a driver on the passenger seat, or mounted to the center console of a vehicle.

It should be noted that the device of the invention may run off the computer in a cell phone and indeed communicate with other devices using wifi, blue tooth or other data services present in a cell phone. A smart cell phone may plug into a convenient slot in the device, and calls made using the big display of the device. If the cell phone has a laser projector in it, this projector can via appropriate mirrors and other optical elements act as the projector of the invention herein. Thus certain classes of the cushion devices would need only provide their own sensor unit, or could even use the sensor unit of the cell phone if its projector were so equipped.

It is a goal of the invention to provide method and apparatus for sensing touch locations and control detail state or position.

It is a goal of the invention to provide method and apparatus for improving visibility of labels or other important information.

It is a goal of the invention to provide optical means for projecting on what can be substantially curved surfaces at low cost, which surfaces can also be used for sensing and are suitable esthetically for placement into a vehicle instrument panel.

It is a goal of the invention to provide a rugged projector and optical sensor based system for use in the car or other locations requiring freedom from vibration and other environmental effects.

It is a goal of the invention to provide means for manufacture of unique optical elements used in the invention.

It is a goal of the invention to provide a method to optimize projection display light reaching the driver and passengers in a vehicle.

It is a further goal of the invention to optimize the amount of light and/or other aspects of information such as lettering or graphics size and placement relating to a control task at hand.

It is a goal of the invention to provide for means to optically distribute light to driver and passengers of a vehicle from a projection screen, and where possible to improve the contrast of the screen in conditions of high ambient light in the passenger compartment of the vehicle.

It is a goal of the invention to provide method and apparatus for providing an easy to use audio or other system for a car, which fits in a double din slot in the instrument panel thereof and allows the unit to have a screen surface larger than the slot.

It is a goal of the invention to provide a method for reducing optical backscatter from the screen and control surface and in attenuating incident sunlight thereon.

It is a goal of the invention to provide a rugged, safe and lightweight interface for computers which can provide displays of data and respond to a variety of intuitive inputs on screens of the device and which can be used in home, car, or office applications on ones lap, on a desk or attached to a seat or instrument panel.

It is a goal of the invention to provide a unique and easy to use interface accessory for cell phones, and to utilize the services of the cell phone where possible to lower the cost of the interface.

Further features and advantages of the present invention will be set forth in, or apparent from, the detailed description of preferred embodiments thereof which follows.

### BRIEF DESCRIPTION OF THE DRAWINGS

FIG. 1 illustrates an embodiment the invention having a rear projection screen and a separate control surface and employing a prism in the optical path from a projector/sensor unit preferably optically connected to the prism.

FIG. 2 Illustrates a double reflection prism embodiment having a separate screen and control surface mounted to the prism and optionally employing a variable shape mirrored prism surface to enhance resolution in the upper display region.

FIG. 3 illustrates a prism embodiment with the projector mounted below the center stack employing a prism with at least one curved reflective surface which may for example be curved to compensate the projected image for distortion, or to achieve desired screen effects.

FIG. 4 illustrates a minor based embodiment with the projector mounted below the center stack.

FIG. 5 illustrates a method for reducing optical backscatter noise from the screen and control surface.

FIG. 6 illustrates a prism embodiment of the invention, in this case having a control surface provided by the prism face itself, and small enough to slide in a double din slot in a car dashboard.

FIG. 7 illustrates another prism-based embodiment of the invention in which the components are arranged to mount in a Double Din audio slot or otherwise be located in a vehicle center stack or other application.

FIG. 8 illustrates a control system used to preferentially illuminate or provide information in those areas being worked by the driver or passenger of the vehicle.

FIG. 9a illustrates a portable “cushion computer” embodiment of the invention for use primarily on ones lap, in the home or car, or on ones office desk.

FIG. 9b illustrates one example of the optical arrangement for both projection of information onto the screen/control surface and determination of inputs made thereon.

FIG. 10a illustrates the embodiment of 9b with communication to a remote computer and a scanning laser projector with a different optical delivery arrangement.

FIG. 10b illustrates a cushion device of the invention with a smart cell phone and dock.

FIG. 10c illustrates a curvilinear screen type cushion device.

FIG. 10d illustrates a perspective illustration of the device including a screen with two knobs, on which a virtual keyboard is being projected.

FIG. 11 is a block diagram of a remote computing embodiment of the “cushion computer” invention.

FIG. 12a illustrates a person using the “cushion computer” invention on their lap having an adjustable angle feature.

FIG. 12b illustrates a person in a car using the invention attached by Velcro or other means on the back of a front seat of the car.

FIG. 12c illustrates a person using the device in the right front seat with the device attached to the instrument panel, which device includes a dock for a smart cell phone of the user so as to allow the invention to be used as a cell phone interface.

FIG. 13 illustrates another smart phone interface accessory.

### DESCRIPTION OF THE PREFERRED EMBODIMENTS

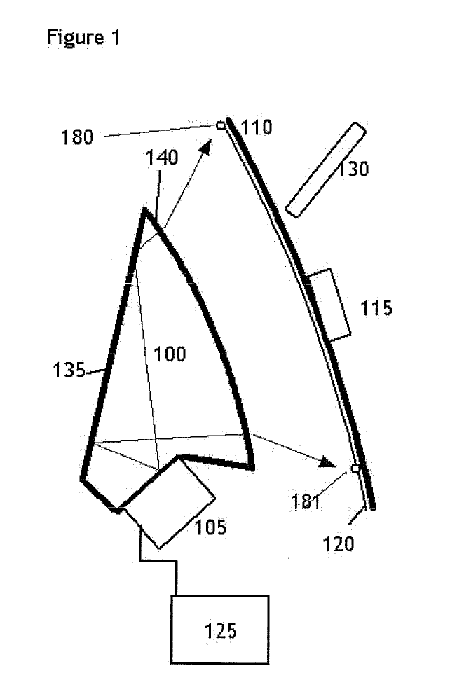

FIG. 1 illustrates a basic embodiment of the invention employing a optical quality plastic prism 100 with polished faces in the optical path from video image projector 105 to screen and control surface 110, to which a knob 115 (or other physical control detail is mounted) and further containing diffusion backing material of 3M Vikuiti brand beaded black sheet 120, as has been described in co pending applications. The projector is controlled by computer 125 and desirably further includes an optical sensing function to sense knob position and touch of a drivers finger 130. Computer 125 reads out the optically sensed information and controls the sensing and projection function. Based on the data determined, action is taken to change the display and control vehicle functions as needed.

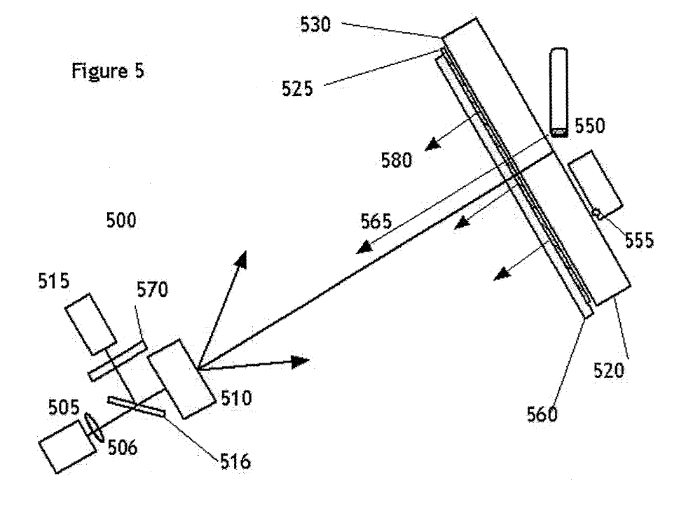

A number of different projectors may be employed, such as Mitsubishi pocket projector having a Texas instruments DLP image engine, but the preferred type is the small, Symbol Technologies laser scanning projection device shown at the SID conference in San Francisco in June 2006. The projector in this example has its output window optically coupled for example by optical cement to the adjoining prism face such that light from the projector (and returning to the sensor unit preferably incorporated into it as disclosed in FIG. 5 or my August 2006 provisional and other co pending applications) can pass without significant reflection.

The prism Rear surface 135 (in this case metallic coated for best reflection), can be flat or curved in one or two planes in order to tailor the projection angles (also in conjunction with the computer scan minor angle drive) for the projected image for correct width, height and distortion correction on the screen and control surface. Preferably one wishes have if possible have generic prism device usable for different vehicle centers stack screen and control surface configurations, with computer correction of the display and sensing programs for all center stack screen and control surfaces within a range. The correction can be stored by part number of the screen and control surface or vehicle, and/or can be automatically calculated in situ using reference locations on the back of the screen and control surface such as reflective targets 180 and 181 (also disclosed previously) which can be sensed by the sensor of the invention and used to correct the projection and sensing.

Curved surfaces can be employed where desired on either the reflective face 135 as noted, or the refractive front face 140. These curves may be convex or concave as desired, and can be a mix of curvatures if desired generally providing variable density displays as well. For example, ⅔ of the scanner rotation sweep and data can be concentrated into the top third of the screen if desired to maximize resolution and brightness if desired in that location.

Typically the screen and control surface 110 is rigidly affixed to the prism, but can be separate as shown in this figure. Or it can be affixed with compliant mountings if that is desired (if separate, or too compliant, compensation for position may be required and the sensor unit of the projector/sensor unit can actually be used, if desired, to align the projected image to the separate screen, as was disclosed above and in my August 2006 provisional.

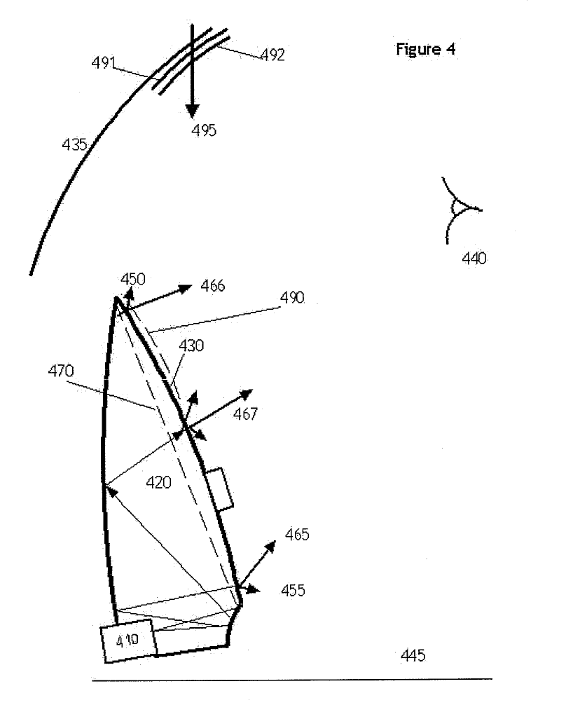

An advantage of this prism version, as opposed to minor only versions such as shown in the TV art and in FIG. 4 below, is that there are fewer surfaces which can get water condensation on them (a special vehicle problem also because of the air conditioning vents in the center stack). And it is a solid object and vibration free, such that the image doesn't vibrate going over bumps in the road for example.

The Prism can be made of Lexan, Lucite, or other optical grade plastic and machined or molded. In either case, some faces will need polishing and generally speaking, some will also need to be coated with silver, chrome or other reflecting material. Optical quality has to be good, but not abnormally high, as super fine detail is not needed in the car for at least the basic function of displaying large labels and graphics.

The shape of the mirror faces or the refractive face 140 may be shaped as desired to direct light to other places than shown. For example this can be used to cause light to exit the prism normal to the prism surface if desired. Fresnel lens elements can also be incorporated into the prism face to cause a change of direction of exiting light from the prism if desired. This can be used to direct more light toward the driver for example, and less toward the floor or windshield or roof.

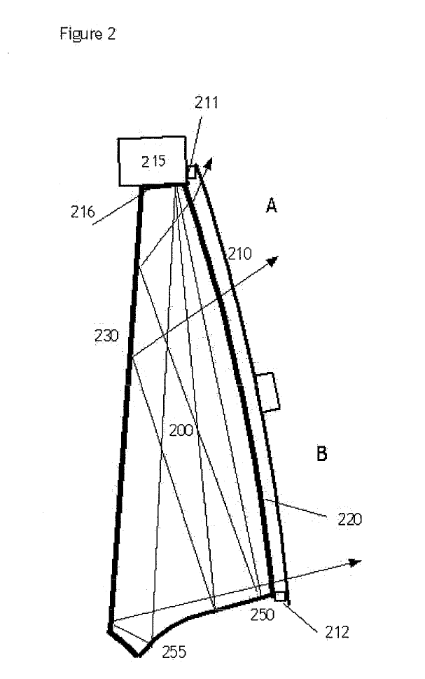

FIG. 2 Illustrates a double reflection prism embodiment 200 for a tall center stack application having the screen and control surface 210 mounted to the prism by mounts 211 and 212 and other mounting points not shown as desired. It also illustrates a variable shape mirrored prism surface to enhance resolution and brightness in the upper display region A compared to the lower region B.

While shown with the same shape as the output face 220 of the prism, control surface 210 can have a different curvature, since it may be desirable to make different screen and control surfaces work with same prism type, in order to achieve high volume production of the prism. This version is one of many potential embodiments that essentially provide a lengthened vertical beam path from the projector device (e.g. a Symbol laser scan projector or a Mitsubishi DLP Pocket projector).

As in FIG. 1, the output window of projector 215 is optically coupled to the prism top face 216, and the rear surface 230 of the prism is coated with a metallic layer or other material to reflect light back into the prism proper.

The bottom mirror coated surface of the prism in this example has varying shape (rather than just being flat or one type of curve), comprised here of a flat region 250 and a convex curved part 255. This means that for a given scan angle of the projector sensor unit scanning mechanism (two orthogonal scanning minors in the Symbol technologies unit) a larger zone of the screen surface is swept when traversing region 255, than region 250, thereby increasing resolution and generally speaking brightness possible at the top of the screen with respect to the bottom, as is desirable as the top gets most of the ambient light striking it, and the top is what the driver looks to for detailed information, such as an image, or telematically transmitted text or play lists or the like. Note that with analog scanning projectors such as the Symbol one can program the scan to give more or less resolution, if the laser spot is well focused.

It is noted that one or more of the minor surfaces can be curved to spread light differently across the screen (in the direction out of the plane of the drawing) as well or alternatively providing variable brightness and resolution in that direction as well. For example the mirror surface 230 could have a quasi-flat section in the middle, and via curvature at its edges, provide most of the divergence nearer the edges, in order to fill the screen in the cross car width direction out of the plane of the drawing. This then spreads the projection out over the whole large screen, but keeps the most pixel density, and resulting additional brightness in the middle two thirds or 3 quarters of the width where desired data most likely is (both to be viewed and sensed). The periphery is generally decorative in the vehicle instrument panel case, and probably most other cases where the RTD approach is used.

Taking this one step further, one can have a minor surface (or an equivalent refractive surface of the prism) which is tailored to the shape of the screen, and accounts for the angles used in projecting from what ever position the projector is locates. This specialized surface could be on a refractive or reflective member external to the prism as well.

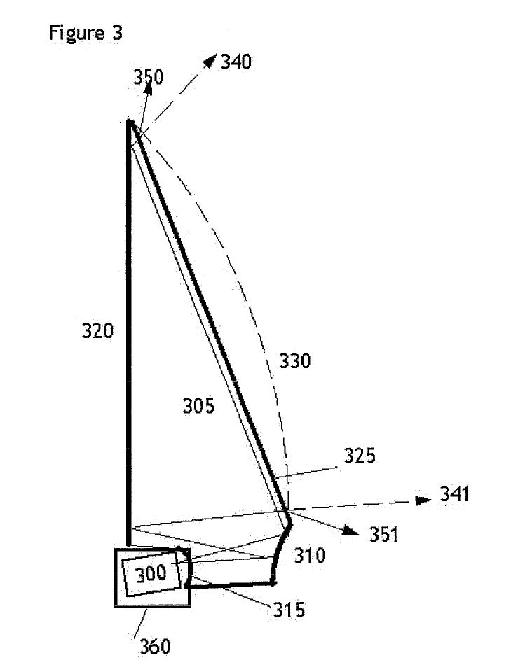

FIG. 3 illustrates an embodiment with the projector 300 mounted to a prism 305 with at least one reflective or refractive surface which may for example be curved such as 310. This can be to provide larger screen coverage, for distortion correction (especially keystone distortion in the cross-car plane), or to achieve desired screen effects such as accentuating the density of projection in different regions of the screen, as discussed above. In this example as opposed to FIG. 2, the projector is located below the center stack, generally a more convenient location.

As shown light from the projector passes thru curved surface of the prism 315 whose shape is chosen in this case to have its normal vector at each point correspond to the projection direction from the projector, so as to minimally deviate the projected light as it enters the prism. This is not necessary, but may be optionally used. The light from the projector bounces off curved mirror surface 310 and then off rear reflecting surface 320 and exits from flat refractive face 325. As above, the reflecting surfaces are metallized or otherwise coated to cause 100% reflection to occur.

The output refractive surface or a reflective surface may be curved if desired to direct light in the horizontal plane (out of the plane of the drawing) angularly from the direction parallel to the fore aft axis of the car. This can be used to correct keystone distortion where in the FIG. 3 example the width of the image is less at the bottom than the top. However it may not all have to be corrected, as the center stack screen surface is itself smaller at the bottom in many instances. If desired may be also or alternatively be used to angularly displace light in the vertical direction. For example if the output surface is curved in a manner shown in dotted lines 330, the light will proceed substantially normal to the output surface as in rays 340 and 341 rather than be deviated from the surface 325 as rays 350 and 351. Correction using the refractive and reflective elements of the prism is generally preferred to use of a Fresnel lens as in the TV art, as the image is smaller and the user is closer to it (typically 25 inches away), and the laser scanning projector in particular may have unusual light problems where the small laser spot hits the juncture of the Fresnel ring elements.

The box 360 is provided to seal the projector with respect to the prism if possible to prevent buildup of condensation, dirt or other things on the projector elements or the entrance prism surface 315.

Where the scanning laser type of projector is utilized the scan angles can be programmed to alternatively correct the keystone or other distortion or do so in conjunction with a mirror correction.

It should be noted that in some cases total internal reflection can be used within the prism not requiring metallization of the surface to provide 100% reflection. It is also possible to use one face in a TIR mode for incident rays from the projector, and have the rays be re-reflected back through the face at higher angles and exit the prism.

FIG. 4 illustrates a minor-based embodiment with 2 curved reflectors 400 and 401. The projector 410 is mounted low in the housing 420, which in this case rigidly holds the mirrors with respect to the projector and with respect to the screen and control surface 430. The unit so packaged can be slipped into the center stack of the vehicle as a unit. Note that in this example the control surface and screen comprises one side of a preferably sealed housing also comprising the sensor/projector and minors. Alternatively a window such as 470 (dotted lines) can be used to seal the mirrors and projector volume, and a separate control surface used. And as a further alternative the projector can launch the light through a window into the housing, rather than be comprised within it.

The screen contains typically diffusion means such as 3M Vikuiti, microspheres, black stripe lenticular screen material or other such members known in the art. As noted elsewhere, Vikuiti as very high contrast in sunlight and has been generally preferred. But Vikuiti and many of these approaches has a problem in that it diverges light in all directions and particularly in some directions we don't want in the car application. For example, it is not desired to have light such as ray 450 proceeding upward toward the windshield of the vehicle 435, which may be reflected back to the drivers eyes 440 and thus is annoying, especially at night. As disclosed in co pending applications, where necessary a shield or visor or instrument panel “eyebrow” maybe be provided to stop light from the screen from hitting the windshield and/or to block sun rays such as 495 from hitting the screen and making it hard to read.

As another example, it totally wastes light to have light such as ray 455 directed to the floor of the vehicle 445. Thus it is desirable to have a screen that diffuses light in the cross car direction at about +/−45 degrees to the longitudinal axis of the centerstack in the fore aft direction of the vehicle. But in the vertical plane, that of the drawing, the desired angles really only have to be such that from any point on the centerstack where information is desired to be seen, the angles have to be such that a driver or passenger in the right front seat can see them. When one includes the different seat positions and heights of drivers, a volume of space then defines the angles needed. It is also generally desirable that back seat passengers, if any, can see the screen, so light in the longitudinal direction is desired in that case as well but is much less important than say for the driver.

Just from the drawing of FIG. 4 it is apparent that from the bottom of the centerstack ray 465 is making an angle of 45 degrees to the horizontal approximately (though less to the normal to the screen surface 430 at that point). But at the top, ray 466 is making only 15-25 degrees for example (depending on the vehicle and the drivers height).

This problem was discussed in a copending application and a Fresnel-like prismatic surface introduced to provide varying deflection and dispersion from the different screen locations. The goal is to minimize rays such as 450 and 455, and redistribute the light to maximally reach the persons in the vehicle as described. Prismatic members and diffusion particles or surface roughness treatments can do this, but they do not easily provide for absorption of ambient light with a black layer such as used in lenticular screens or even better, black beaded screens. In addition, for cosmetic and tactile reasons it is desired that the front of the screen and control surface facing the user be smooth or mat finished.

The problem of light at the top of the screen and control surface deviating toward the windshield can be solved in some cases using a louvered film 490 shown in dotted lines (also called privacy film, or light control film) such as that made by 3M (for example type ALCF-P), assuming that the light proceeds normal to the surface to which the film is attached, and that the angle theta of the surface to the horizontal axis is so great that the angular pass band of the film allows light to hit the windshield. Typically this band is 60 degrees (with the slats of the louvers horizontal as desired here) or +/−30 degrees, which means that a ray 466 angle of approximately 20 degrees as shown, would allow light at plus 50 and minus 10 degrees from the horizontal to pass. This is ok as can reach the driver's eyes, but substantially not the windshield in such a manner as to reflect into the driver's eyes. The louvered film also tends prevent sunlight from overhead from reaching the diffusion surface of the screen.

Ideally it may be desirable to have louvered films or other louvered constructions running horizontally out of the plane of the drawing in the screen surface itself which would have varied angles of maximum transmission, being aimed at all points if possible at the average driver location, effectively having their maximum transmission axes as shown in the drawing relative to rays 466,465 and 467, rather than just having the maximum transmission normal to surface 430 to which the material was adhered. Note however for centerstack screens and control surfaces shaped as in FIG. 4, the normal direction generally points more or less to ward the drivers eyes within the +/−30 degree cone of the 3 M film, though at the very bottom it may not, depending on the how close the bottom of the surface 430 is to the floor. Since the problems of sunlight are minimized in the floor location, the need for the film is lessened there anyway.

FIG. 5 illustrates another aspect of the invention as it applies to embodiments herein and those in copending applications, and concerns a method for reducing optical noise caused by backscatter from the screen and control surface. In one particular example, Vikuiti films on the back of the surface were noted to cause returned light signal levels of as much as 50% of the total signal from a knob reflector on the other side of Vikuiti film (drivers side) and even more of a percentage from a touch indication. This creates optical noise, which is undesirable.

For example consider FIG. 5 wherein a laser scanning sensor/projector 500 having a laser section 505, a scanner section 510 and a detection section 515 according to the invention illuminates a screen and control surface 520 having a Vikuiti black bead film 525 or other dispersive element on its rear face 530. A lens 506 is generally used to focus the laser beam (comprised of the three colored laser beams and an IR one if used for sensing) to obtain a fine spot on the screen 520 for maximum resolution, and to offset defocusing effects of curved mirrors if used.

It is desired to detect the reflection from a finger tip 550, or a knob target 555, by sensing with the detector section 515 observing via beam splitter 516 light passing back through the screen and control surface including the Vikuiti film (although in some cases this film is removed from behind the knob reflector excursion region). In this embodiment a new feature is added, namely ¼ wave retardation sheet 560. Such quarter wave plates are known in the art, and serve to rotate the plane of polarization of the laser beam (either visible or IR, as desired) passing through material of the quarter wave plate.

Light from the finger (or the knob or other control reflector) such as ray 565, travels back through the quarter wave material and becomes retarded therefore by a half wave. It then passes though polarizer 570 in front of the detection module, which polarizer is crossed to the polarization of the outgoing laser beam. In this manner the background scatter from rays such as 580 from the back of the Vikuiti screen is eliminated as they are substantially blocked by the polarizer 570. While the light level to the detector is less, the signal to noise ratio is much better. This allows the gain on the detector to be increased, aiding detection of signals from fingers in particular.

This same approach can be used with DLP or other types of projectors with LED or other light sources, if the source in question has been polarized by any known means.

An added bonus can be achieved by putting a polarizer 491 of the same polarization as 570, together with a quarter wave film 492 on the back of the top of windshield 435. This causes the worst sun incident from overhead 495 to enter the screen in a polarized rotated fashion which when passing through quarter wave material 560 becomes rotated to a direction crossed with respect to the polarizer in front of the detector 570 (or any other detector used by the invention to see controls, knobs or touch such as a TV camera). This then substantially eliminates many sunlight effects causing stray light within the optical sensing system.

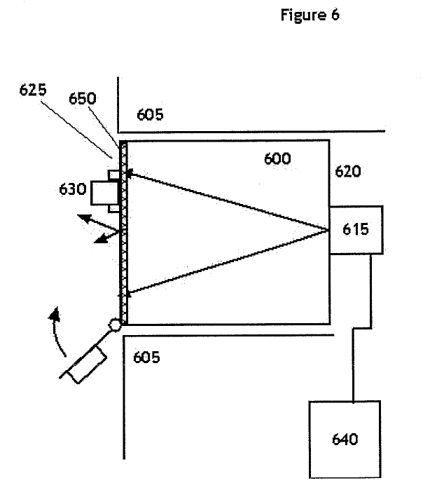

FIG. 6 illustrates a prism embodiment of the invention, in this case for a double din slot in a car dashboard or other application. In this example, prism 600 is manufactured to fit into a double din radio slot of a car dashboard 605. The prism has attached to its rear a Symbol Technologies laser-scanning projector with integral sensing unit according to the invention 615 whose output window 616 is optically cemented and thus coupled to the rear prism face 620. The projector projects onto and senses information on a screen and control surface 625 provided on the front surface of the prism face itself. Data including finger touch of the surface or position of a control such as knob 630 on the control surface 625 is determined by the integral sensor and fed to computer 640.

In this application, the front surface 625 of the prism includes near its front surface 625 scattering particles such as refractive micro spheres 650, which form the screen of the device. Alternatively roughened portions such as may be created by sandblasting can be used to diffuse light from the face 625 or a surface relief diffuser (SRD) can be used. It is generally desirable to tint the plastic screen to make viewing into the device difficult, and improve contrast, albeit losing projection light in the process.

This application further illustrates the optional use of a flip up/down control plate 670 including knob 675 which can be brought into operation by flipping it up in front of face 625, where it can lock into snaps not shown to hold it against the surface 625 until it is desired to get it out of the way of the screen again for example. The sensing of this knob from the rear through the screen by the sensor/projector unit, particularly workable if the divergence from the face is relatively low at least in the region of the knob, whose control position is also seen by the sensor of the projector shown.

The scattering surface/knob mounting surface is on the prism exit surface. In this version one cannot use Vikuiti on the prism face, as there is no air interface at the rear of the beads. However in lieu of micro-spheres 650, one could space a member with vikuiti on its rear surface away from 625 away and seal it if desired with a nitrogen or dry air filled gap for example.

Note that the micro spheres ideally might be not spherical but of a shape and orientation such that light is scattered as much as possible toward the driver and passengers eyes as noted in FIG. 4.

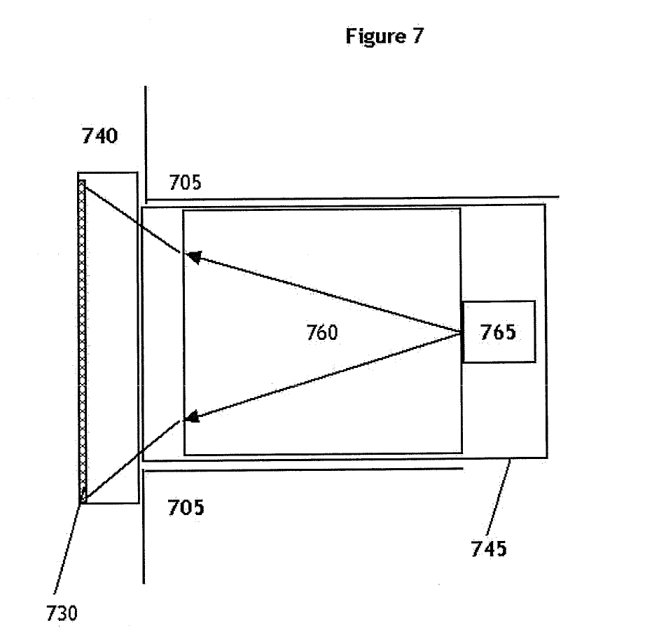

FIG. 7 illustrates another prism-based embodiment of the invention in which the components are arranged to mount in a Double Din audio slot or otherwise be located in a vehicle center stack or other application.

The screen and control surface 730 with Vikuiti on its backside can be over 8.times.6 inches in extent (10 inch diagonal, 4:3 aspect ratio) without sticking too far out of dash 705 having the standard double din slot. The screen 730 is attached to housing member 740, itself attached to member 745 which slides in the slot in the dash and holds the lexan prism block 760 and projector 765.

The surface of member 740 can be rounded at the edges if desired, with lettering even projected on the edges if substantially in view of the projector.

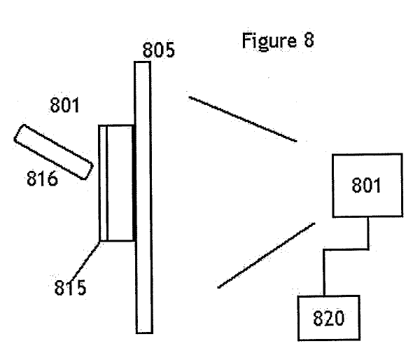

FIG. 8 illustrates a control system used to preferentially illuminate or provide information in those control regions being worked by the driver or passenger of the vehicle, a concept also discussed in co pending applications. For example consider the example of FIG. 8 wherein a sensor unit (which may be part of a projector unit as in this case, or separate) 801 detects that a knob 810, mounted to screen and control surface 805 is being turned, for example by noticing a slight change in the rotational position of the knob as taught in my co pending applications. Or it may sense that the knob has been just touched, for example by detecting the touch on the screen face 815 of the knob by a finger 816, or via a reflection from the drivers hand over the knob or near the knob, or by alternative electronic means such a capacitance change in the region of the knob. Alternative means for sensing knob or other control position can be used too, such as variable resistors or incremental encoders (where one increment of movement would trigger the projector action discussed here, for example in this case).

Once the event of operating this knob (or other control) has been confirmed, the projection unit controller 820 (which may also be a computer shared by the sensor readout) may, if desired, command the projector 801 to allocate more light energy into the control whose touch or turning has been sensed. This allocation can be achieved by dwelling longer on the control label in terms of the projection time. Alternatively one can increase the light source power during illumination of the label or other graphic, for example. This can be done regardless of what type of projector is being used, but is most convenient with the laser scanning type. When doing this, one generally has to reduce the visibility of other portions of the display, which typically would be in areas not related to the information relevant to the control being worked.

It is noted that the command to specially illuminate the knob and its region, can also cause different or additional information to be displayed. One possible mode is to simply increase the size of lettering for the knob and its graduations or other indicia, eliminating or downsizing other information in the neighborhood that is not needed for the task at hand.

The control being worked in this case can be a physical control such as a knob, or a touch icon, or any other control of the invention.

It should be noted that this same approach may be made in a general sense. For example, if it is determined by analysis of sensed control input data, or if the user himself has entered a command which designates such a strategy, it is possible to for example send more light to the top of the display than the bottom (especially useful if a sensor has detected excessive ambient light hitting the screen) and it is also possible to concentrate the light in the middle of the display rather than at the edges where little meaningful labels or data occurs. Such concentration is particularly easy with a laser scanning type projector as one need merely restrict the scan to concentrate on the areas desired. Or if the scan covers all areas, one can drive the lasers harder in the middle, and less on the periphery so as to keep a similar duty cycle for the lasers, but a much different intensity distribution on the screen.

One may also choose when using a DLP or other kind of projector to favor one color over another for purposes of label or other illumination. For example, an extra powerful green led might be used, which could be heavily driven in certain periods to illuminate labels. A red-green colorblind person could choose colors that he could see better too.

While the invention above has been presented in a car instrument panel context, its application is not so limited. For example the prism of FIG. 2 can be used to create a sensor based screen and control surface usable for flat objects such as remote controls and keyboards, as mentioned in the referenced application U.S. Ser. No. 11/832,134 filed Aug. 1, 2007 entitled Reconfigurable Tactile Control Display Applications. Particularly FIG. 22 thereof, which illustrates a remote control unit for a TV, and FIG. 21 which illustrates a reconfigurable keyboard computer.

A similar apparatus (which also may be used as a TV remote) is now shown in the form of a more general purpose device, which can be used on ones lap, while in a seat or in bed, or laid on the surface of an office desk. It can be used by itself or in conjunction with another display, computer, keyboard, mouse or other input or output device. This device resembles the car center stack application in many ways, but would generally employ a mirror arrangement for expanding the projection path rather the solid prism arrangement described in some embodiments above as it is desired to keep the device as light as possible for lap use and portability. In addition, the lap use generally does not require as much light energy, as the ambient light is generally much less than encountered in a car during the daytime. This in turn aids the use of self-contained battery power and reduces heat.

This portable embodiment of the invention is herein called a “cushion computer” to avoid confusion with laptop computers as they are presently known, and to further highlight a major feature of the embodiment, namely that it is meant to generally be softer, lighter and safer than a normal laptop computer. While able to possess some or all functions with a laptop, it also expands the applications possible, especially for average non-technical users who may enjoy the ability of the invention to use classical physical controls (e.g. knobs) and finger gesture interaction not possible with today's laptop computers.

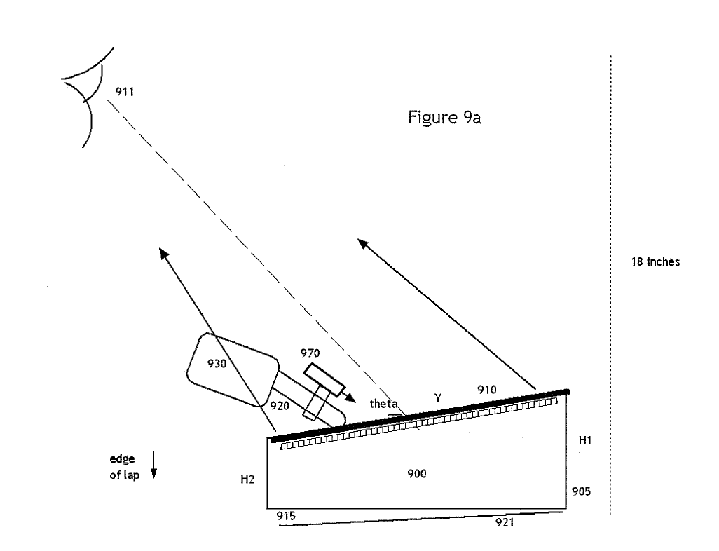

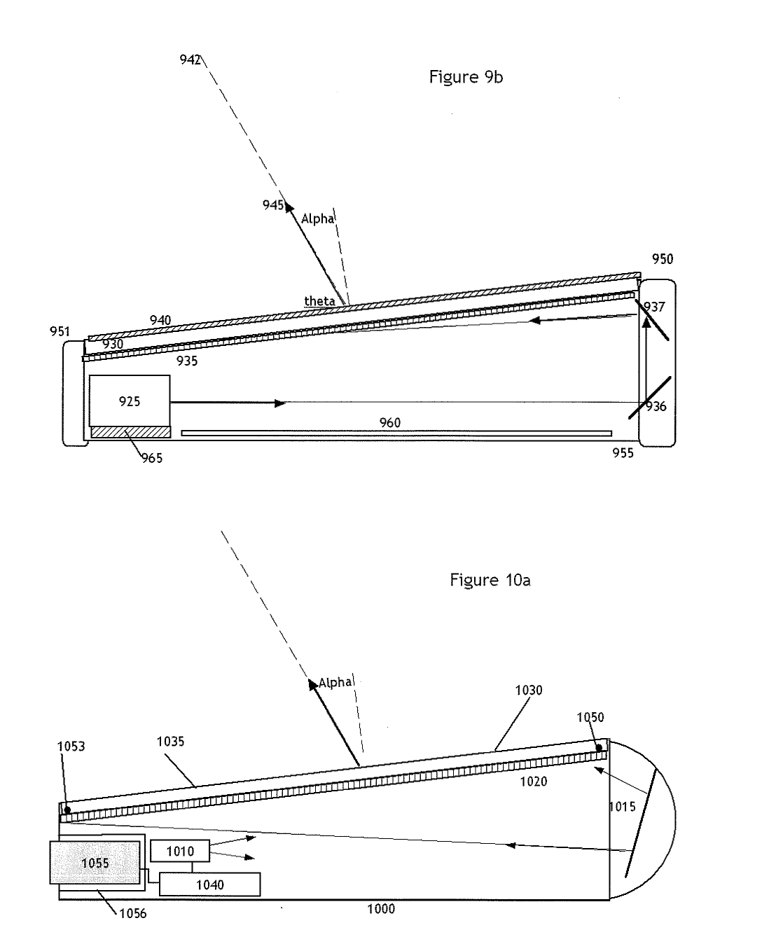

FIG. 9a illustrates a “cushion computer” device 900 of the invention having housing 905, which is in its mechanical design arranged in an exemplary embodiment to tilt the viewing and control surface 910 toward the users eyes 911, when the bottom of the device 915 is situated on ones lap or other more or less horizontal surface such as a desktop. The user interacts with the device with finger or fingers 920, and may use his or her fingers to adjust any physical controls on screen 910 as well as taught in co pending applications Typically light images are projected using a video projector from within the device onto the rear of screen 910 and thence to the users eyes after undergoing diffusion from the screen.

The approximate dimensions of the device in one example are a height H1 of 4 inches in front (away from user) and H2 of 2.5 inches in the rear, with a screen and control surface having a width “X” of 15 inches in the direction normal to the drawing and having a dimension “Y” of 11 inches in the direction away from the user. The tilt angle of the screen with respect to the horizontal is be fixed by these heights H1 and H2 (and further considering the tilt of ones lap, if any). However the angle can be can be made adjustable by known means over a range, for example by adding an angular tilt plate 921 to the bottom of the device. As noted previously, this “cushion computer” version of the invention would generally not employ the solid prism arrangement described above as it is desired to reduce the weight of the device for lap use, for portability, and for safety reasons in certain cases. The unit is turned on via a switch provided anywhere desired, for example on the sides or back. A typical angle theta with respect to the horizontal from the center of the screen to the users eye when used in on a lap is 40 degrees. It is desirable to direct light to the eyes, in order to not waste light by scattering all over the room for example.

It should be noted that a device having a screen dimension XY as described above has a screen size 18.6 inches diagonal and an area of 165 square inches—an area over 60% larger than a typical 15.4 inch diagonal laptop computer. It is my thesis that this added area brings considerable value to the user, in that it enables much more useful interaction with the screen via multi-point and other finger gestures, and allows useful controls to be placed on the screen while still leaving room for finger activity. In addition it becomes big enough that it may be more easily shared with another person who may be seated nearby. This size and gesture advantage also enables applications such as games, amusements, and activities for seniors or small children or other technologically challenged persons that would not be possible otherwise. It also provides added ability to work the device when large lettering and controls are needed.

FIG. 9b illustrates one example of the optical arrangement for both projection of information onto the screen/control surface and determination of inputs made thereon. One example of the function of such a device is as follows. A light valve based projector such as Texas instruments DLP type 925 incorporating solid state sources such as LED's or diode lasers for maximum reliability and minimum power consumption projects on to the rear surface of plastic screen 930, via two minors 936 and 937 which taken with the projection lens of projector shown are designed using known anamorphic or other principles to tailor the size of the projected image to the approximate dimensions D and Y of screen 930. The light from the projector is spreading out of the plane of the drawing at a wide enough angle to fill the desired amount of the screen in the direction out of the plane also working in concert with the minors in the optical train.

The arrangement in this example is similar to that disclosed in Cotton et al. U.S. Pat. No. 6,457,834. The screen 930 contains 3M TRAF turning film 935 (which may have turning angles of Alpha of 70 degrees (or even 81 degrees if “right angle” film) on its rear surface The screen is generally flat in this application, but can be curved on the edges or elsewhere if desired for stylistic or other purposes. The prisms may if desired be molded into the rear surface as opposed to be in the form of a film. This is possible with the solid plastic screen used herein, which was not the case in the Cotton device.

Optionally the screen may also have molded in to its front surface micro prisms 940 (or a less turning type of micro prism film such as a 20 degree type). These micro prisms more efficiently direct the light 945 from the screen to the users eyes the axis of viewing of which is generally at an acute angle Alpha to the normal to the screen surface in this application.

In this application, screen diffusion is provided both by the prisms and by micro spheres dispersed within the screen material of screen 930 in a manner known in the projection screen art, which also can include provision of lenticular elements on the screen face to spread light sideways (out of the plane of the drawing) if desired. However it is noted that the viewing angle of a lap use device to the screen is quite constrained at least for the primary user on whose lap it sits, and thus spreading of light to half power points of more than +/−20 degrees in any direction away from a line 942 from the screen center to the viewers eyes is not generally required. The “gain” can be quite high of such a screen, as only low dispersion is needed when the primary person viewing the screen is the using person shown. This is a major factor in limiting the lumens required from the projector, allowing cost, temperature performance, and battery life to all be optimal, at least in so far as this regard. And the use of a small projector allows a lightweight device which can be easily used on ones lap, and provides increased ability to pad the device such that it can absorb drops, and generally provide a friendly feel to the user.

The use of the aforementioned high gain screen would be less appropriate if two or three users sitting side by side on a couch were using the device, in which case using the unique interchangeability feature of the invention, one can interchange the screen with one having a wider divergence angle in the lateral direction between the users. This allows the exciting experience of finger gesture and multi-point activity to be shared. Such multipoint activity can be with two fingers of a user, fingers of two hands of a user, fingers of a user and a person seated next to him or her and so on. And it can include determination of information from separate objects not part of a person as well, such as writing instruments or cards and the sensing device may also be used to sense controls such as knobs or finger touches on the screen. The sensor is in this instance incorporated with the projector as shown in co pending applications and in this example using for example a LCOS or DLP based projector, or by a separate camera or scanning laser sensor as shown in co pending applications.

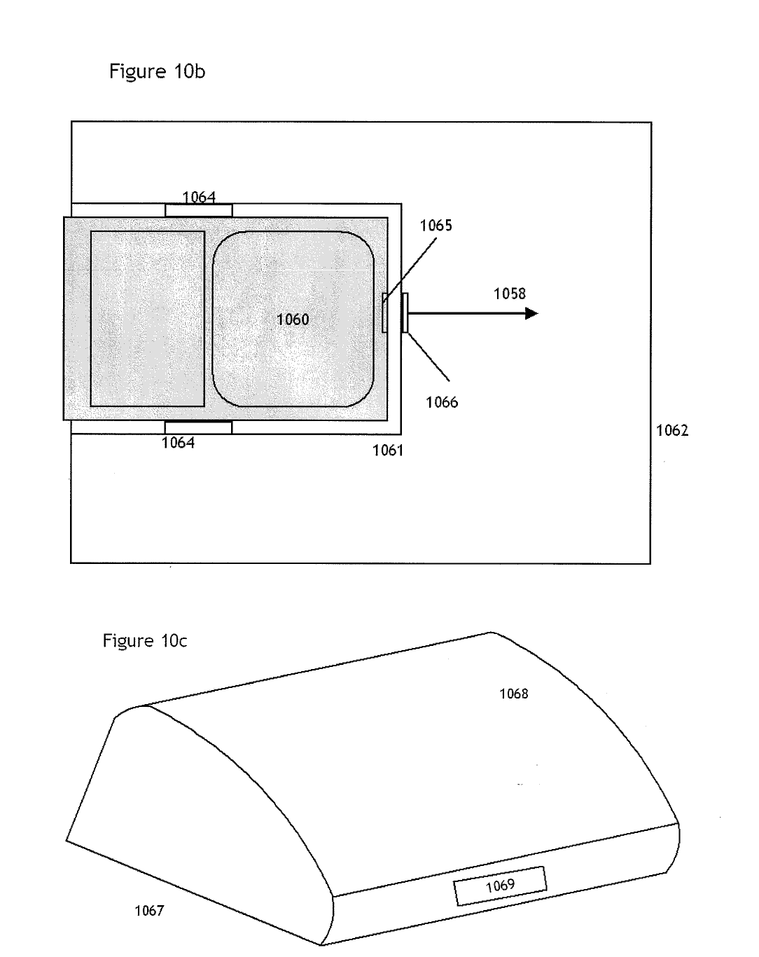

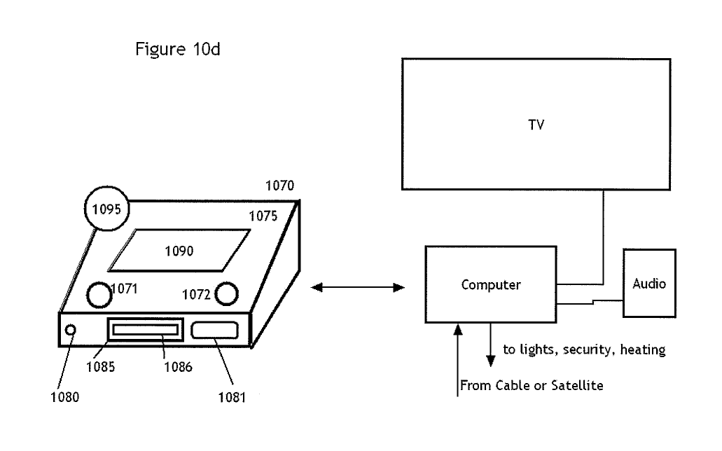

In this application an onboard computer motherboard 960 is provided to allow all functions desired to be performed on board the device using known methods. Other electronic components may be located in the housing 955 in regions not in the projection beam path. In the example of FIG. 10 however, the principal computing functions are performed at a centralized location (usually in the home, office or car) allowing the weight and cost of the Cushion computer (in this form really just a peripheral user interface to a computer, including for example a TV set or other device connected to the computer) to be reduced along with battery power consumption.

The projector can be shock mounted with elastic base 965 to help absorb shocks. The cushion computer of FIG. 9 is equipped with added cushioning material in this case pads 950 and 951 front and rear to assist in cushioning falls and bumps to the device. Other padding can be provided as desired. These pads can even be interchanged with different color schemes and such to personalize the device. The corners can be extra padded to avoid hits there.

It is noted that a laser pointer (or other suitable concentrated light source of preferably a limited range of wavelengths) manipulated by a user can also be used as an input to the device herein, as disclosed in some of my co pending applications. For example, consider an optional laser generator 970 on a ring or otherwise attached to the finger of the user 920. The laser beam point of impact on the screen 910 can be sensed by the sensing camera or scanning device of the cushion invention and used to select information displayed on the screen. Where desired a device may use two beams, one in the visible for the user to see, and another at the infrared wavelength of a filter used by the detector unit, if used. If only the infrared was used, the user would then rely on seeing a video displayed indication of where the sensor saw the beam hit, which in a way is better a it is the true point known to the computer.

FIG. 10a illustrates an embodiment 1000 similar to that of FIG. 9 but utilizing a laser scanning projector, and employing an off-axis Fresnel lens-like optical arrangement which may be specially designed to optimize light propagation to region of the users eyes similar to that shown in my previous applications.

As shown in the figure, a scanning laser projector 1010 such as a Microvision brand (Redmond Wash.) Pico projector, or Symbol LPD, which may be alternatively used instead of a DLP type as disclosed above and in co pending applications. The projector directs light over a wide projection angle in both of its angular axes to a mirror (which may be aspheric) 1015 and thence to an off-axis Fresnel lens 1020 placed just before the screen 1030. The Fresnel lens can be a specialized type having prismatic facets also designed to direct and converge light at different angles from the screen toward the user in a manner like that shown in FIG. 7 of my co pending application filed in January 2005, where a somewhat similar vehicle problem exists in that the users eyes are close to a relatively wide expanse of screen. Some directing elements may alternatively or in addition be molded into the front or back surface of the screen if desired, for example via optional micro prisms 1035 on the front face. The projected image can be at or within the dimensions XY of the screen, and can if desired roll over into the edges of the device for added visual effect as discussed in other applications As further disclosed in other co pending applications, a photo-detector based sensor device can be incorporated in the projector to allow it to sense objects on the screen such as fingers or knobs while scanning a projected image if desired. Or the sensing may occur in a separate sensing cycle. Typically the sensing operates outside the visible range using an additional near IR source (e.g. 880 nm) so as to not disturb the user.

The combined projector and sensor unit 1010 (which has its own electronics and even its own communication if used in cell phone activity) is interfaced in this example to a small electronic module 1040 used to control the cushion device of the invention and process data taken from controls, fingers, objects and the like, and communicate via wireless means (or alternatively wire) to a remote computer which can run an application in question such as a game, and communicate back to the cushion device new images and sounds which can be acted on and displayed.

As discussed in co pending applications the sensor may be used to determine the location of features such as datums 1050 and 1053 on the screen with respect to the projector/sensor unit, and correct the position with respect to the screen. This allows correction for miss-positioned screens after interchange, or for small changes in shape of the housing or screen after for example a case where the cushion device is dropped on the floor.

This example of the invention differs from that shown in previous examples in that it may optionally, and with a cost saving, utilize the computing resources and communication capabilities of a smart cell phone such as a blackberry “Pearl” device 1055 made by the RIM company of Waterloo Ontario, which may dock in a slot such as 1056 in the housing of the invention The screen/control surface of the invention then can become the control surface and screen for the cell phone 1055 when it is plugged in, allowing one to use, if desired all the functions of the phone from the screen and control surface of the invention, such as keyboard entry for email, navigation of real time maps, playing games, dialing phone contacts and the like. Because of the large display and control surface space thus provided (relative to the diminutive sized display and keys of most cell phones), many additional phone functions can become practical, for use anywhere one can dock the phone in the invention (or otherwise connect the phone to it).

In addition, and as a further cost saving, future cell phones may also contain the video projector and even the sensor unit to display and sense information on the screen and control surface of the invention. This cell phone based projector sensor unit, can be used for other purposes increasing justification, and in this case there is very little electronics, if any, required in the device 1000. If desired, when docked the cell phone could be recharged from a larger battery in the invention, or by AC power (or car 12 VDC power) if the cushion invention was connected thereto. It should be noted that while the cell phone can plug into the cushion device to share resources and optionally get charged up in the process for limited operational periods the cushion invention can also run completely off the cell phone, including the cell phone battery assuming of course that the services both hardware and software needed by the cushion are present in the cell phone. In this mode the cushion is a true peripheral to the cell phone.

10b illustrates added details of the device of FIG. 10a in particular in regard to it serving as a human interface accessory for a smart cell phone. In this example the smart cell phone 1060 is just pressed down and snapped in place into a recess 1061 in the housing 1062 of a cell phone interface accessory of the invention, allowing some or all of the existing cell phone controls to also be visible. Spring clips 1064 hold the phone in place until removed by the user. The cell phone shown has an integral projector whose beam 1058 is shown exiting the cell phone window 1065 and entering a window 1066 of the housing in order to illuminate the minors and screen thereof as shown in FIG. 10a and not shown for clarity here. In this version the screen would generally be designed to allow access to the cell phone.

Because of the use of rear projection, the corners of the cushion device can be rounded and indeed if desired the whole device and its screen can be rounded in one or two planes for effect. This is particularly easy with laser based projection devices with large depth of focus. For children for example, the device could be at least partly shaped like a cartoon character, such as Mickey mouse. Indeed if it was, or in any case, it could be used to show cartoons or educational programs as well. Even very small children could use the device as a toy, for example pulling on various screen control sliders to make sounds or images. And yet by changing the screen, a grownup could use it later for another purpose. As a way of illustration, a classic toy called “Etch-a-Sketch” can be made with the invention this way, having event enhanced properties. Its screen, if directly analogous, would have two knobs.

FIG. 10c illustrates an embodiment 1067 having a screen with a slightly curved and rounded surface 1068 for stylistic effect to make the device seem more like a common cushion in ones home. This example has a slightly deformable screen 1068 made of vinyl. This screen can have a transparent gel or other resilient backing for support if desired. An optional cell phone interface slot 1069 is also provided.

FIG. 10d illustrates a perspective illustration of the an embodiment 1070 without padding, in this example having two knobs 1071 and 1072 on the screen 1075 and optionally including a microphone 1080 and speaker 1081 to allow audio interaction with computer applications. A dock 1085 is provided to insert a cell phone 1086 into to allow the device to utilize miscellaneous services of the cell phone, including computational and a projector if applicable. A virtual keyboard 1090 is shown being projected. This keyboard can be provided with deflecting keys as shown in my co pending applications. Active force feedback to the keys can also be provided if desired, also disclosed in previous applications, which could also in some cases make use of a vibrator present in a cell phone.

Just as there is analogy between the cushion and the car center stack relating to the irregular shapes and curvatures of the screen and control surface which are possible, so too is there an analogous ability of the device disclosed herein to have portions cut out For example cup holder slot 1095 which might intrude into, or reside in, one of the optionally interchangeable screens.

In the case just shown, remote might mean simply across the room next to the large screen TV display. The remote computer (e.g. a Pentium core duo media center type computer), would contain the software and interfaces to interact with other devices as needed which were to be operated by the interface of the invention. These devices could include audio and video devices, internet services, home automation devices such as furnace and security system controls, lighting and the like. Because of the convenience and ease of intuitive operation of the invention it is felt that the one or more examples of the invention indeed could become the primary interface to these devices by persons in the home.

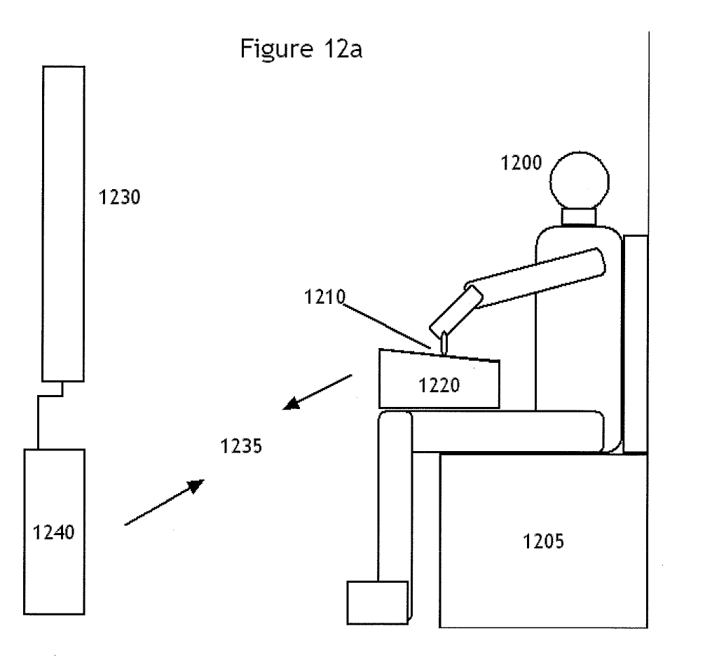

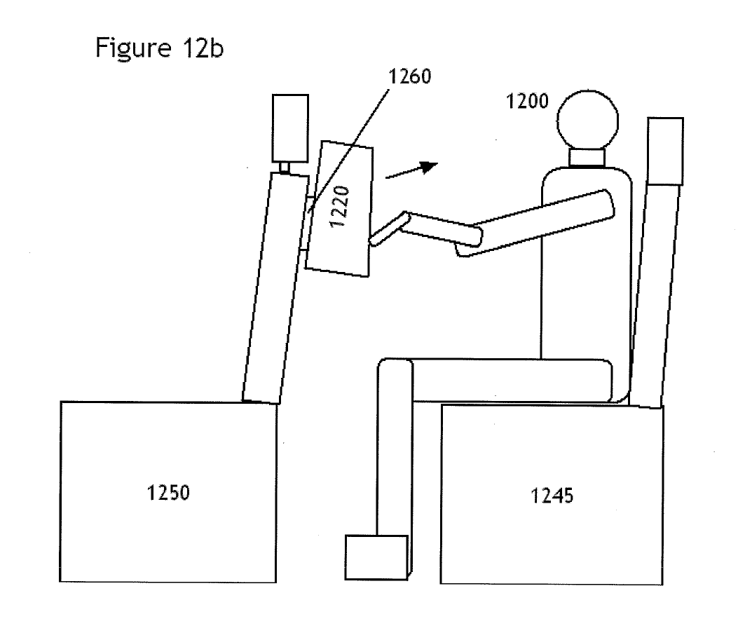

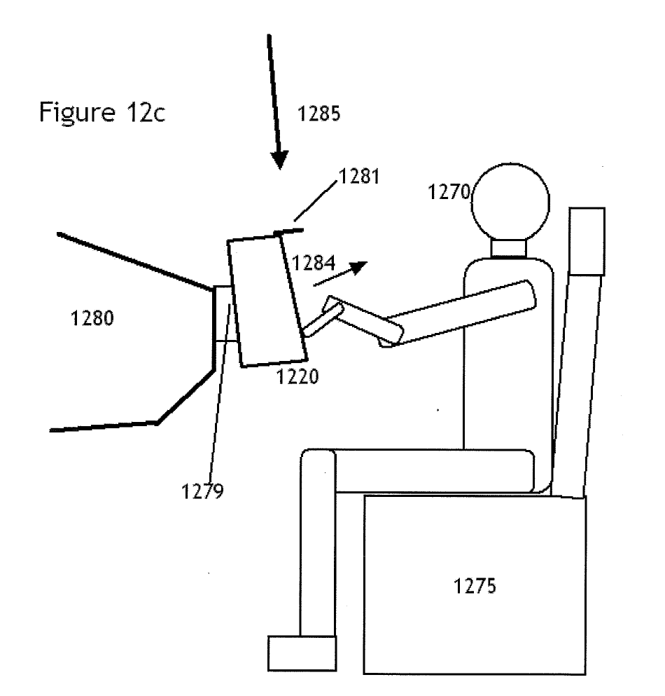

Weight, heat, and cost are reduced in this example because one can optionally use a remote computer, relying on battery power only for the projector (and its display electronics) and sensor, and the communication (e.g. Bluetooth or Wifi) to the remote computer. The remote computer in question can be for example, in an office, in ones home (for example a Media PC near a TV set) or in a car center stack with other infotainment devices. This allows the device to be easily used in the back seat of a car by children or grownups. The car application (also shown in FIG. 12) of the invention is much safer than using a conventional laptop computer in the car, both from the point of view of injury in a crash, and in the degree of protection from breakage and spills in normal use within the car. The “cushion computer” of the invention is padded and with minimal hardware incorporated within it, if it runs off the infotainment computer of the car for example. It can even be connected by wire, such that wireless communication electronics and battery power are not required. It can be hand carried into the car by the user, enhancing justification for use outside the car as well. Alternatively it can be stored in a pocket within the vehicle or the back of a seat and if desired, used in that position.

As noted above one user of a single cushion device is concerned, the light from the projector can be largely directed toward the users eyes using screens with modest divergence, also known as high gain screens. This allows projectors of say 35-50 lumens to suffice even for screens of the size XY discussed above, especially when used indoors for example in a TV watching room. Such projectors are expected to be both small and inexpensive for projecting video from a cell phone onto a screen the size of a piece of paper, priced below $50 in quantity. For example having a screen size of 11.times.15 inches (a 19 inch diagonal), 60% efficiency delivering light from the projector to and through the screen in such arrangement, yields brightness to a user of 550 nits, which for example exceeds most laptop computers today. Even with more lateral divergence to accommodate a person or persons seated next to the user, competitive brightness to today's laptops can be delivered. The screen could be 12.times.16 without much change either (a classical 4:3 aspect ratio layout). Smaller screens would appear even brighter, or would allow less powerful projectors or more inefficient optics to be used, both lowering cost in most cases.

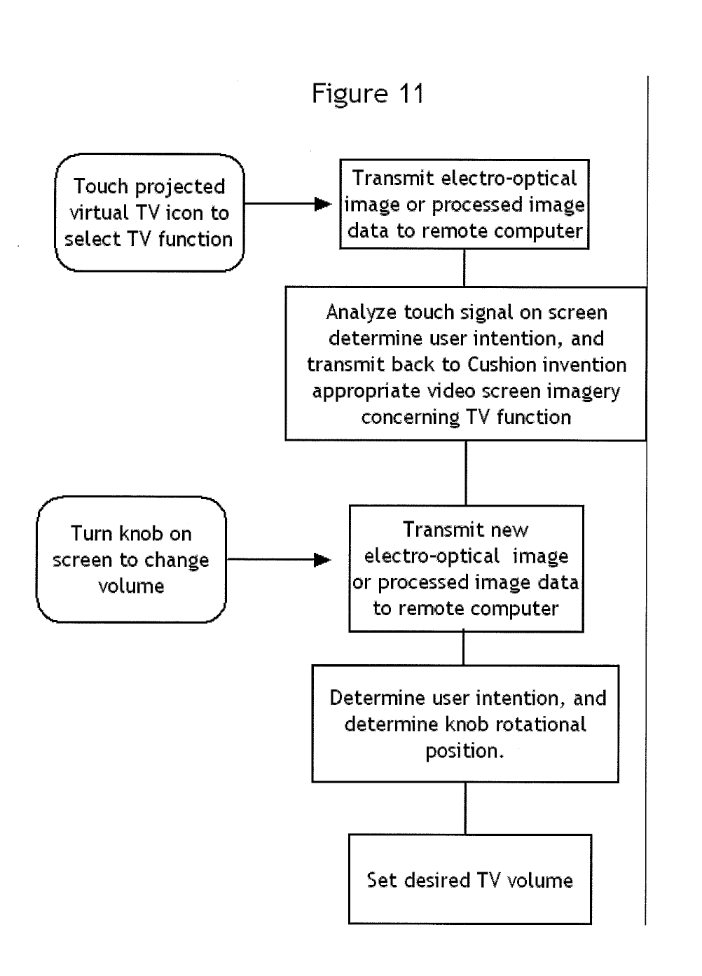

FIG. 11 is a block diagram of the operation of one aspect of the device of FIG. 10d, for selection of a TV show and the control of its volume, in which a remote computer is used. This diagram alludes to two possibilities, ether transmission of the raw video image taken with the electro optical sensor (TV camera, or scanning laser type typically) to the remote computer for analysis, or the pre-processing of that data on board, and transmission of the x-y positions of physical controls and/or touch coordinate values (and maybe z force too) determined to the remote computer. This last possibility is faster, and requires much less transmission bandwidth, but requires added components in the cushion device, which in turn raise its price, and increases weight, remembering that for most users in the home battery power would be desirable. The number of pixels per second which need to be transmitted for the sensing purpose may not be that high, if fine resolution of objects on the screen is not required.

Another issue is transmission of TV video rate information back to the device, if one is going have this information available on the device. This generally requires higher bandwidths than the image processing transmission. Suitable electronics for such transmission are made by the Avocent company.

Video compression techniques may also be used such as MPEG4 to reduce the bandwidth required, albeit with some latency or resolution loss. This can allow use with the Internet of the invention both for sensing and for TV image display generation. In this case the remote computer referred to can be really remote.

The screen of the invention as discussed elsewhere in co pending applications can be interchangeable which brings considerable value to this application. For example one screen might incorporate knobs and a keyboard with physical switches such as shown in FIGS. 21 and 22 of the referenced July 2007 application. Or just one or the other.

Alternatively the screen might have a completely smooth surface, which would be used for finger gestures including multipoint finger activity with one or two hands. This smooth surface can easily include a virtual projected keyboard touch screen surface, and optionally that can have a different tactile feel if the areas in which the keys are projected are made to give way for example in a more elastic manner than the surrounding screen as also disclosed in co pending applications. The interesting point is that one can interchange these screens, and have combination ones. And as also disclosed previously even mission specific screens which are interchanged in whole or in part can be provided. These might correspond to particular games, or TV programs or other activity, and provide not only a different visual presentation via virtual software but also a different tactile presentation as well. A sound mixer as discussed in my January 2005 case could also be accommodated. Here the screen of the lap use device can be a miniature version of the mixer shown in that application, using real controls such as knobs sliders and/or virtual controls such as virtual knobs or sliders also as disclosed in co pending applications.

In situations where multiple family members have cushion devices of the invention operating using a central computer in the home, each unit can when making a wireless connection for example, engage the computer to call up programs stored for their device, including accounting for any differences in the screen interface. For example, if Mary logs on, the fact that she had two physical knobs on her screen used for volume and tuning of a TV set when she was in Entertainment mode would be known. When Joey logged on however, it would be previously entered in loading software into the central computer, that his screen was devoid of physical controls and used for finger gesture based and other touch screen type activity.

Typically the device can have rounded edges and other measures taken to make it more visually and texturally appealing than the simple drawing shown. Images projected can rollover on to the edge's of the device too and carry various colors patterns and other things to make visually interesting. These can dynamically change as well if desired.

The lap use cushion computer device as pointed out can also be used lying on a regular desk. A separate keyboard may be used via suitable USB or other connection, if the virtual keyboard made possible by the invention is not desired. An elemental keyboard may for example be incorporated and slide out from the housing of the cushion.

The invention can be used with common office programs such as WORD or EXCEL using multi finger gestures such as pinch or bracket as shown in my co pending applications which can be used to move or change information, or to move a cursor for example. Alternatively or in addition, a single finger on the screen can be tracked and used directly as a mouse if desired. Or the conventional keyboard mouse arrangement can be used.

If ones work concerns images, then these can be manipulated directly on the screen as disclosed in co pending applications and more recently in Microsoft's newly introduced Surface computers for example (http://www.microsoft.com/surface/).

The lap use cushion device herein has many purposes, and may be used in the car, home or office and elsewhere. It's generally a bit larger than a laptop computer, and of a convenient size that you can hold on your lap while seated, whether you're working or when watching TV or whatever. But for the screen size it doesn't weigh as much, nor is it as fragile as a laptop computer. And it has interchangeable screens, multipoint and gesture capability. While a computer motherboard may be part of the device it is in many cases not necessary have the computing part in the device. It could be WiFi or Bluetooth connected to a computer in your room or car. One can also wirelessly transfer data to a television and have a TV image come back to the lap device screen.

While generally larger, it can be the size of a typical laptop computer (e.g. screen diagonal 12, 14, or 15.4 inches today) if desired. This allows the screen brightness to be proportionately increased for any given projector choice. For smaller devices, the projectors used with cell phones are very attractive due to their size and cost, and power draw or lack thereof. For example even with an output of 25 lumens, a cell phone projector can provide substantial brightness on a 10-inch diagonal high gain version of the invention.

The invention has the ability to have completely interchangeable screens and with them tactile devices. Nothing else known has such a feature. This means that it in one case it might have a completely plain screen, which can be used for a multi-touch and gesture interactions. Examples might be painting organizing one's photographs or the like. Clearly this screen could have all virtual controls if desired—knobs, sliders, etc as disclosed in my co pending applications.

In another case the screen could have tactile keys for a keyboard incorporated in the screen. It is desirable that they only had slight interruptions at their edges so that they didn't disrupt a complete image. This might not be necessary however, and in any case, it creates a reconfigurable keyboard. The invention also can be used for gaming and it should be noted that other controls that are games specific to a particular game can be on the screen as well, such as knobs for example, but also joysticks for, whatever one might wish.

A application discussed in the my January 2005 filed co pending application concerns use of the device as a piano (or other musical instruments) having the big advantage of being able to project information on or near the keys to aid learning, playing and other purposes. This can be done with the invention here using an interchangeable screen having piano keys, or just having virtual keys. It might be desirable given the width of the lap use cushion device and in considerations of ones finger sizes to have for example only two or three octaves at once projected.

From the point of view of doing work using standard computer programs such as Word or Excel, one might choose to use a separate keyboard and this would be particular true if you laid the lap use device on a real desk where it was higher up. But you could still use a keyboard projected virtually that had no tactile feel at all, or use the active feedback or passive feedback aspects of the invention of co pending applications. It should be noted to that it might have tiny little tactile ridges or grooves or other relief elements just simply to help you locate your finger. As noted in other applications it should also be noted that you could have keys that deform the material.

The idea of a screen with physical controls for some specific application has been discussed before in my co pending inventions. Indeed, one can think of all manner of mission specific screens.

A major difference with the invention herein as opposed to let us say a Apple I-phone or the Microsoft Surface computer as presently shown is that we are not asking one surface to do everything but rather having a choice of surfaces. This is a major advantage, and also one that can really only be achieved well with the projection and machine vision sensing approach. Indeed, we are here dealing with several synergistic concepts:

Sensing of touch including multi-touch and gestures.

Interchangeable screen and control surfaces,

Sensing of physical controls that are somehow residing on the screen and generally attached thereto. These include knobs, sliders, joysticks, dials, and so forth, all things that are traditional and known to all members of the population for control purposes.

Tactile relief devices in the screen itself (described at length in co pending applications, and not further shown here).

Active feedback of force signals to the user (described at length in co pending applications, and not further shown here).

Tactile feel of deforming portions of screen, if used (for example under a region where a keyboard key was to be projected for the user to touch).

Sensing of objects on the screen and moved around, possibly using magnetic forces to hold in their place once positioned. Sticky screens could be used in some cases too for this purpose.

It is noted that the screen is also large enough to be relatively in the same spatial context as your fingers and hands. In other words, it's big enough to put your fingers on and feel like you can usefully manipulate data with them.

One application mentioned in my case filed in July 2007 is a TV remote also referred to above. The lap use device of this invention can make a wonderful remote in particular, since you can display TV on its screen, not only the video image of the station you desire or other media source, but also information concerning the program or any other information is helpful, including for example a picture of another station is separate from the one being watched on the screen in order to keep an eye on it for example.

In the same vein as the TV remote, you can use the lap use device disclosed herein to select songs from a play list that may be attached to your MP3 player. This MP3 player it could plug into the lap device or somewhere else such as a media computer that had provisions for MP3 storage and all kinds of other things. The lap use cushion device in this case can be wirelessly connected to the media computer and becomes like a peripheral that simply is used as the human interface for someone seated in a chair or couch—classical locations for people to watch TV or in some cases to work at home or surfing of the Internet. (in a car the media computer analogy is in the center stack and connections can be wired or wireless as desired). The key thing here is that the screen of the lap use device is typically large enough in this case. For example roughly 18 to 20 inches diagonal that it actually provides a good view and can be used for many purposes, and can be segmented into areas where you can see something as well as manipulate other data at the same time without sacrificing one or the other.

Again I would like to come back to the point that the screen can be tailored for the application or for the person using the application. For example on older person might prefer that the cushion screen have conventional knobs for volume and tuning for example. Just like a TV set of 50 years ago. The tuner dial can even be presented on the screen, just as I've shown in other patent applications being done for car center stack's and the audio system You can even carry this one step further and have the very visual presentation on the screen be in an old style for example, the style of a TV tuner from years ago. In other words, something familiar and friendly and the opposite of the computer generation displays which are befuddling to many older people.

As noted elsewhere, the screen can also be completely tailored to the person in terms of colors or patterns designs decorative things of every sort, and can have family photos or whatever you want on the screen as well. It's simply a matter of generating imagery in the computer and driving the projector of the unit.

It is not out of the question to think that customized screens with different shapes, printing, colors etc might be provided for such devices, along with software. Again all of this is in keeping with my previous disclosures for example, one might provide a video game the had a specialized screen that came along with it since the cost of manufacturing a specialized screen with certain controls built into it might be only a dollar or two. The provision of such a thing with a with a $60 software package is not difficult. But these don't have to be games just for youngsters. Indeed they can be games that an older person might play and maybe play either over an Internet link with other persons or by themselves in which you can play against the computer for example. Crossword puzzles, Board games where the people involved are not in your house, but somewhere else. This is shown in FIG. 11 as through the Internet connection.

One other application is to take object such as your finger or a pen and draw on the screen with the computer following your pen and drawing a line behind you if the screen is made sensitive to pressure, which has been shown in my applications. Both relative to fingers and pens, and then the width of the line can increase as you push on the screen more. Children can easily finger paint with the invention in a virtual manner in this way.

Also, it's been noted that you can push or pull on the screen in a lateral motion in the plane of the screen. This can be used to move data around either on the screen of the laptop computer or a TV screen associated with it for example. And any sort of grooves or ridges or other physical relief that might be put on the screen to assist this can as noted in previous disclosures be done.

In the example shown a DLP projector has also been discussed this DLP projector today can be switched very fast. Such that alternating 60 Hz frames (total rate of hundred and 20 Hz can be provided thus allowing stereo displays without flicker. Assuming that user is wearing LCD switch able glasses, which have been developed to be now light can and do not bothersome. Thus the laptop does can also be a stereo displayed to the user is asked some other connotations because one is close to the display. One can also use the stereoscopically presented image in three dimensions to allow you to interact with an image also in three dimensions by sensing. Not only your position and action wine the surface of the screen, but also the distance within some limits of your finger from the screen. Its noted that with high gain screens. Having low diffusion such as might be useful here for or allowing the relatively dim projectors to be used. One generally has a situation where you can see farther out from the screen surface in would be the case for example with the a high dispersion screen such as 3M vacuity.

FIG. 12a illustrates a person 1200 seated in a chair 1205 and using their finger 1210 making a touch gesture on the surface of “cushion computer” invention 1220 on their lap communicating wirelessly to and from computer 1240 controlling the TV 1230 which may be changed in channel, volume or other variables in this manner. The person may use the device 1220 to control other devices controlled by 1240 as well, via different software and video displays on the screen of 1220.

FIG. 12b illustrates a person in a car using the same invention 1220 attached by Velcro 1244 or other means to the back of a front seat of the car 1246. In this example the image is rotated 180 degrees from that shown previous to accommodate the tilt of the device toward the user. The light weight of the invention allows Velcro to be satisfactorily used as the attaching mechanism, though other things may be used such as a hook flipped out from the seat back to hook into the device 1240. An angular tilt mechanism such as shown in FIG. 12a may be used if desired to position the device in angle relative to the user 1250 seated in the vehicle rear seat 1255. The device may automatically plug into the cars own power, and entertainment or HVAC system if desired via a wire connection rather than wireless. This minimizes battery power, and reduces mass making the device safer still in the event of a crash. The “cushion computer” of the invention may also be made part of a toddler seat if desired, or temporarily attached thereto. It runs on low voltage and has plastic parts, most of them soft or reasonably so, safe for use and in case of an accident. Since the “cushion computer” is not confined to the car, but can be taken with you to home or office, it allows one to become more familiar with it.

It should also be noted that seat 1246 could be in an airplane. In this example there might be two other alternative methods of having a remote computing capability that would not expose the cushion device to damage or spills. The first would be to use a cell phone, if allowed, as the computing source. The second is to have an ordinary laptop or other computer such as a PDA stored in ones briefcase under the seat, and use wire transmission to the cushion device on ones lap or Velcro attached (for example) to the rear of the seat ahead.

The car application illustrated in FIG. 12b in which the “cushion computer” invention may be attached by Velcro to the seat, is in part made possible due to the light weight of the device. One can also do this for the right front seat passenger, by attaching the device to the instrument panel using Velcro or other means. FIG. 12c illustrates a person 1270 using my cushion computer invention 1271 while seated in the right front seat of a car 1275. While he could hold it on his lap, in this case the device 1220 is attached to the instrument panel 1280 by Velcro or other means 1279. A slide out sun shield 1281 allows the user to shield the screen 1284 from sun light 1285 coming down the windshield of the vehicle. Note that not only can you change to a new screen; you can flip the interchangeable screen around in some cases as well such that controls thereon face one way or the other as desired.

It should be noted that the device of FIG. 9 or 10 can also be made smaller if desired, which generally serves to increase brightness for any given projector choice. For example, to serve as an Audio Video control, as shown in a previous application, it might just have a 12-inch screen diagonal. Or it may be used as a cell phone accessory, to simply expand the interface of the cell phone and thus make it much more useful when in the house or car or office. As one example the invention described can form part of a briefcase, say the upper part with the screen on top which has a flat working surface which can easily have either a virtual keyboard or one with physically acting keys. This is made possible because of the light weight and ability of the device to at least briefly run off the resources of the mobile phone (and longer if a AC connection is used, or added battery power is contained in the briefcase).

Another device specifically meant as a mobile phone interface accessory is now illustrated. This device has no electronics of its own at all, and simply serves to expand the capability of a smart phone (that is a phone with substantial computational, communication and memory capabilities). It can do this because it relies on the cell phone to have a laser projector, such as a Microvision Pico projector or Symbol LPD with an optional built in IR sensing capability as discussed above and in my co pending applications to sense control positions, finger positions, or other object locations on the screen/control surface of the device. If desired the device may include optional battery power to power the phone to avoid draining the cell phone battery.

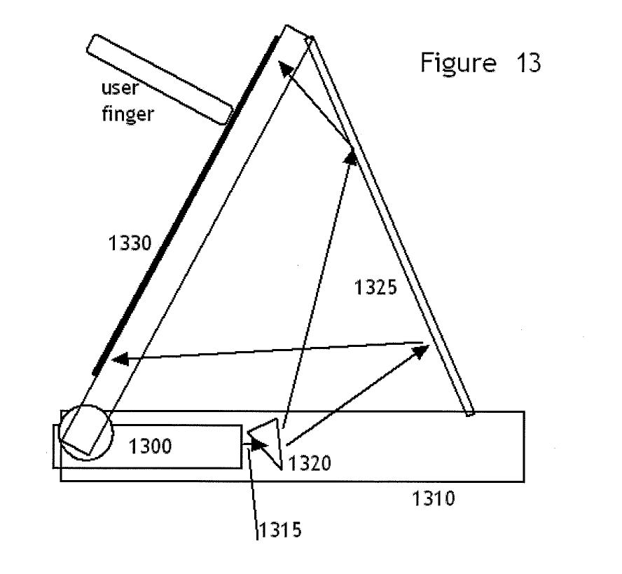

The accessory shown in FIG. 13 is a folding device to minimize bulk when carried. Smart Cell phone 1300 plugs in the front of the device housing 1310. The laser projected two axis scanned beam 1315 from the integral projector/sensor in the cell phone is bent by prism 1320 and after hitting a mirror 1325 impinges on screen and control surface 1330. The screen and the mirror have in the course of opening the device, been lifted up from a locked down position and snapped into position using techniques known in the art. The device is kept rigid in its open state by known means, and may for example use additional struts or other members not shown. This device is small enough to easily fit into a briefcase in its folded form. One takes it out, plugs the cell phone into it, and voila!, a full fledged human finger and vision proportioned interface that's much easier to see and use. And yet at very little cost as all the computation and electronics remain within the phone, and can be used for other purposes without the interface accessory here disclosed.

For example, the Apple iPhone has a 3.5 inch diagonal screen, is 4.5 inches.times.2.4 inches by 0.46 inches and weighs 5 oz. The interface of the invention here when folded for carrying might be 8.times.6.times.1 inches and could accept the plug in of such a phone for example slid in side ways or endways. 8.times.6 gives a 10-inch diagonal display if the whole screen surface can be projected on with suitable optics. The device herein might retail for 50 dollars or less with suitable plastic optics and little or no electronics.

In the event a smart phone (or other mobile device such as a PDA) has a laser projector, but not a sensor integrally incorporated a suitable sensing device can be part of the invention herein, at an added cost for both the device and its interface to the cell phone when the latter is plugged in or otherwise connected. A suitable sensor can be a camera as taught in many of the co pending references or as an alternative example, a scanning type as taught in U.S. Ser. No. 11/355,194 filed Feb. 16, 2006, entitled “Sensors for Reconfigurable Tactile Control Displays” and incorporated herein by reference in its entirety. These sensors can be used in the embodiments of figures above as well. It should be noted that cell phone in the context of providing services could be not just a phone, but a PDA or other similar smart mobile device.

The “cushion computer” invention herein can also be used by the driver of the car, for example when driving alone. He just puts the “cushion computer” on the right front seat or the console of the car, possible with another cushion or apparatus to tilt it toward him. Because the display is big and easy to interact with, the driver can much more safety select play lists for example from an MP3 player plugged into the system, whose lists show up on the screen of the “cushion computer” and can be scrolled or selected by sliding and other gestures on the screen. Or with a conventional knob which can be turned until the song in question is found, and then pressed in to select it. This knob can be big too, with the album cover of the song if desired displayed on screen within the knob if desired. Indeed with the interchangeable and special “mission specific” aspect of the invention, it is possible to think of this screen being totally devoted to audio tasks while driving. Indeed, it could act as an auxiliary to the main audio system of the vehicle in this manner.

It is also noted that when the screen is suitably non dispersive, the device may be used to digitize printed matter or other data placed on the face of the screen with the printing toward the sensor. You can even use that data to program the system for example to automatically go to a website related to that article. Such a concept is shown in my co pending applications of which this is a continuation in part.

It is contemplated the cushion invention in the home (or for that matter a car) might be used by multiple members of the family. Each member could have for example their own screen or even multiple screens each these would for example be kept in a screen storage cabinet the screen could be encoded such that when you place it on the device. The software to operate that screen is called up from memory of the computer or their onboard computer if present. Types of screens might range from one for a toddler who could have little tracks and other things were little trains would run around and you would run your finger in the track and chase the train for example, to a sophisticated keyboard, which also could be interchanged for different games a teenager might use for gaming.

Because the projector in this device is one is being developed presently for cell phones. It is likely that it will be designed in such a way as to draws little power as possible for the luminance produced it a lot of the computing capability is remote it than the power requirement in the machine is simply that to drive the projector and provide the sensing capability, as well as to communicate with the external computer. It is thought that this is in its summation a relatively low power draw, which means that the laptop computer device could easily be battery-powered without cords of any kind. In thinking here to of batteries that don't themselves way, a lot such that the complete laptop computer device would way. No more than 1 a laptop computer today and likely quite a bit less assuming the materials of the housing and so on are made of relatively lightweight materials. Speaking of materials it should be noted that no real dangerous or breakable materials are in contact with the user. The housing may have a soft touch area around the screen and then the plastic screen itself, which in some cases actually could be made deformable. Several co-pending cases disclose using deformable screens actually for measuring purposes. For example, in short, the cushion computer may be made, light and safe. Safe from being broken, within reason, and safe as far as an object that could hurt anyone. It is considerably safer for example in this regard than a normal laptop computer. This is particularly in regard to the screen and a keyboard, which is in the case of a normal laptop, can be ruined by simply spilling a Coke or a cup of coffee on it—very likely in some situations.

The cushion device interface argues for integration with mobile phones. In the simplest version, you simply plug your phone into the cushion computer and its display becomes an aide to using the phone. The cushion device can even be completely run off the computing resources of a smart phone. Indeed the cushion display is so big that the actual phone functions can be down in a corner of the display as desired. But any data is projected through to display can be use up the whole screen, if that's what you want. Again it's all very convenient because it's is simply sitting on your lap in the preferred manifestation. Or sitting next to you in a car, or attached to the instrument panel as disclosed.

There is also the possibility of using this a device in a more friendly and a soft and cuddly way. As noted above, the device can have rounded corners can have fabric covering on its outside except for the plastic screen area, and generally feel good. Let's take a closer look at this.

As noted above, the device can be light, if the projector is small. There is no heavy backlight or glass substrates or screens as usually associated with an LCD or other type of flat panel display. The screen surface of the invention, while normally rigid can also be deformable itself and in fact some of my invention show methods of using that information to actually make measurements of either finger locations forces or to objects contacting the screen. Because of the projection path. The device basically as more air inside it than it does parts, and in this particular instance. A laptop implies a sort of up intelligent “cushion computer” and if you were. It actually is quite useful that way namely that it's not happy. It's rugged and can be thrown around a sort of, and generally. If the main computer board and associated or sophisticated hardware are remotely located. Really the only thing inside the box is the projector and sensor controls and drivers and the communication circuitry such as Bluetooth or WiFi or both.

As noted in co pending applications the unit can where DLP and other projectors are employed, easily employ a 3D projection using switch able glasses providing example 60 HZ image refresh rates for each eye.

Probably the main use for the devices in the home where one would normally have a lap use device and use it as a remote control for other devices in the home particularly the entertainment devices. But by no means limited thereto, it can control any automation (e.g. heating, home security system, lights) in the home simply by being an interface to a computer to does that or if it has a standalone computer board a perhaps the control can be more originating in the laptop does device and simply WiFi the information directly to the appliance to be controlled without going through another computer.

In that type this device can be more or less taken to any room in the home and if it uses a computer to its in the home its stationary for example. There isn't a lot in the laptop does device this means then that it doesn't cost a lot of money, Norway very much this in turn means that you can afford to have more than one of them in the home. Perhaps one for each person in the house that's desires one. A central computer can easily tell, who is a using the services, and it's very likely using known techniques that all persons can timeshare the computer. The importance of this can't be understated if you'd think of this is simply that a large display, where you each person could interest in essence have their personal TV. It's a lot more friendly and less weight and then having LCD displays that you would have similar services It's also much friendlier have already pointed out at you can spill things on it and not get around something you could never do with a typical LCD today.

The same characteristics make it ideal for taking in to ones car as also shown in FIG. 12, it links via wireless or wire to the computer of the car typically associated with the center stack of the car, which takes care the entertainment resources in the vehicle There really is no need to build LCD screens into the backs of head rest for example, which is done today at considerable cost. The whole issue of building such things into the car has safety issues associated with it as well as user friendliness. In this case, the lap use device can be made in such a way that it is safer and portable such that justification can extend beyond just occasional rides in the back seat. And it can be easier to work for the user on their lap as well, particularly for Internet and gesture tasks. While the invention can be made as part of the seats in general, it seems best to think of it more as either a lap use device in the classic form or an intelligent “cushion computer”.

Note that the invention may, if desired, be used for purposes that are often ascribed to tablet PCs. This is particularly case if the device includes the computing capability normally associated with such tablet PC devices. Clearly as disclosed above, the device would have a larger screen than is typically used, but might not weigh any more, and perhaps less especially if it could utilize remote computing resources and reduce complexity inside its own case.

There are several industrial applications of tablet PCs for example, doctors can carry them a hospital to make notes, access patient records and perform other tasks. This could be done in a somewhat similar manner using the instant invention since has a substantially improved and more intuitive multipoint and gesture touch screen capability, as well as the ability to incorporate physical controls. The ability to change screens is a major feature as well. This particular feature can make the device quite usable in an office environment, where it different members of the work team all might have different screens to fit the task that they need to do or their own personal preferences. Or other could be a general screen with only parts of the screen replaceable in the manner of the cards that I've described in previous co-pending applications. For example, portions of the screen could include mission specific data and interfaces.

In the office environment, one might consider the invention to be a replacement for the ordinary office phone. It could for example, set on a desk, just like a phone can be used to dial calls. Assuming that the communication from the device to the call network was enabled of course, the device can do way more than act as a phone given that it has video interface capability of for both multi-touch finger gesture and physical controls as well is what and what one might call more normal touch screen functions. There is an interesting question to as to whether the fact that it can be very light weight could bring something to the office environment as it might to other environments.

Certainly the hospital application where a nurse or doctor or nursing home care provider might carry the unit with them is interesting in this regard. Indeed, one might consider they cushion device to be essentially a clipboard or nurse's notebook, and other applications where one might today think of using a tablet PC. The device in question could have more intuitive interface capability than a tablet PC, but also more flexibility as to its size shape, and weight. You can clean it much more easily and don't have to worry about dropping it too. The patients too can utilize the same sort of device, but more for their enjoyment, and communication with relatives or the hospital data network or whatever.

The changeable screen ability also allows the cost of manufacture to be reduced, since the same basic unit shown in FIG. 9 or 10 for example, can be used for all customers or users, just by changing the screen/control surface and the software of the device. For example another application is in factory where you're doing quality control using a tablet PC or out in a construction site and so forth. The goal here isn't to reinvent applications of tablet PCs, but rather to see if the invention aids the application or reduces its cost. The key point to remember though is that this at the invention is designed basically to rest on something and if the mode of operation is to use it while standing for example. If this is the case a convenient handle may be incorporated not only to carry the device, but also to hold it with one hand while working it with the other. The invention in one form at least larger than one might normally wish to hold even though it may not weigh anymore. The trade-off for this extra size and whatever difficulty it brings is that you have a much larger surface in which to interact. And this would be particularly interesting for gesture-based finger motions including multiple touches, an optional feature. For people that might use these devices standing up is a convenient handle may be provided which could also be a carrying handle.

As pointed out in the January 2005 application and others, the screen/control surface could be that of an audio mixer containing various controls such as knobs and sliders, which would be of interest for example a music enthusiast in the home, or car.

It should be noted that weight and power consumption are reduced also because all sensing of touch or physical controls is in the simplest example employing a laser scanned projector with an integral sensor, done by one detector and one IR Laser. There are no circuit boards and DAC devices for knob or switch signals, and no complicated conventional resistive touch screen circuitry or the like. Everything comes from one signal source, though more processing in the computer may be required.

At a price falling between $150 and $200. The cushion device can actually be a high-end electronic toy or a high-end remote control for a TV in an audio system or for that matter anything else one would like, while always keeping the simple interface and being easy-to-use for seniors and others. Why can it do this? Because of the interchangeable screens and the large easy to see screen and easy to work and commonly familiar controls such as knobs, switches and sliders. And if you are willing to use your cell phone for these purposes, the electronic cost maybe be largely eliminated. It's noted that a child can use a petting type gesture employing multiple fingers or hands just as discussed in my 1995 application of which this is a continuation in part. This use of multi-point gestures allows all sorts of games to be played by users of the device, who may interact with other users over the Internet, or even other users in the same house. One can create virtual musical instruments on the screen and play them with your fingers. The screen can be changed to one having physical members associated with it such that pinball or other games can be played on it as in my 2004 filed case. Other screens can have some features in Braille that may make the device useful for blind persons. The unit can be sealed and is in any case of low voltage, so it can be used around water.

At this point, it is clear that the potential world market for these devices is easily beyond the one billion units. The price is low enough such that multiple units can be present in a given home all interacting with the same basic computer system, if that is desired. In poorer homes multiple users can share the same unit by customizing it to their own needs to the software and a very low cost interchangeable screen and control surface.

These same advantages also would allow the unit to be used in a number of industrial commercial settings for examples schools and hospitals were the easy to clean aspect is another advantage and many other locations.

The device would seem to have a great deal of value in a car. One reason for this is that you don't have to buy separate units for the car and for the home. The unit is also padded, and non-threatening, less so than the conventional hardware being put in car rear seats today. In fact because of this it can also be safely used in the front seat attached with Velcro or something else to the instrument panel in front of the right front seat passenger. Because of this dual use aspect that is in the car and in the home is expected that a large number of purchasers would want the device. Since the take rate on vehicles such as minivans offering rear seat entertainment systems is on the order of 40% this right away becomes a big number.

Speaking of multiple uses it is also clear that the device shares a common platform with all variations whether the screen is round square diamond shaped large or small the basic unit is the same. The only electronic variant that would seem to be in a normal serial production would be a unit having a computer or one utilizing remote computing services or cell phone as the computer. Presumably all such devices would wirelessly connect, unless they were meant to plug-in somewhere such as in a car or potentially in an aircraft or hospital, where wireless transmissions may be prohibited.

The ability of the unit to scan into computer memory written and printed matter placed on the screen can allow the unit to actually be used to store documents directly. For example a user may be seated in a chair, and simply wants to store a receipt, phone bill, or something whether in the home, car, or office. This can be easily scanned and sent to the remote computer memory employed. With added sophistication, one can use it to read handwriting or text in the using known character reading programs of that type.

While the invention is thought most compelling when optical sensing of the control and or touch location is performed, it may be that application of the prism and other embodiments herein can be useful even when conventional electrical based knobs and controls or resistive or other touch screens are used with the projector embodiments of the invention.

In addition, many of the friendliness and ease of use advantages of the cushion device and other embodiments can be delivered with displays other than rear projection, albeit at added cost and weight For example a conventional LCD based “cushion computer” of the invention may be built using the teachings of my application of Jul. 18, 2005.

The invention has been described in connection with numerous embodiments, it is to be understood that the specific mechanisms and techniques that have been described are merely illustrative of the principles of the invention, and numerous modifications may be made to the methods and apparatus described without departing from the spirit and scope of the invention.

1. A human interface for a vehicle comprising:
a computer driven video projector;
a screen and control surface on which video images are projected and where a user inputs commands using one or more fingers and/or by actuating a physical control detail located on said surface; and
a housing containing said screen and control surface and said projector, said housing adapted to fit into a slot in the instrument panel of said vehicle.

2. A human interface according to claim 1, wherein the projected image on said screen is at least as big as the available area of the slot in the panel.

3. A human interface according to claim 2, wherein said screen area is larger than the slot area, and the screen protrudes from the surface of the instrument panel.

4. A human interface according to claim 1, further including an electro optical sensor means to sense user input commands.

5. A human interface according to claim 1, wherein said commands relate to control of audio or video functions.

6. A method for preferentially increasing the visibility of information on a portion of a vehicle display screen comprising the steps of:
determining that a person is interacting with the physical control detail in a region comprising a portion of the vehicle display screen; and
using said determination, increasing the visibility of information projected in said region.

7. A method according to claim 6, wherein the light source illuminating said screen preferentially delivers more intensity to said region.

8. A method according to claim 6, wherein one or more colors of light are changed in said region.

9. A method according to claim 6, wherein the light source illuminating said screen preferentially remains on longer in said region.

10. A method according to claim 6, wherein said information is a textural or graphic label of a control function.

11. A method according to claim 6, wherein said display is provided by rear projection.

12. A vehicle control panel:
a physical control detail on a portion of said vehicle control panel; and
variable size labeling for control functions thereof, said labels being largest for those control functions which are actively in use.

13. A human interface to a computer having a display with a screen containing tactile relief details to reference the location of a users finger on the screen.

14. A human interface according to claim 13, wherein said display is a rear projection display.

15. A human interface according to claim 13, wherein said relief detail is chosen from a group comprised of ridges, indents, bumps, grooves and regions of different surface roughness than surrounding regions.

16. A human interface according to claim 13, wherein said relief detail is of a dimension that does not substantially alter displayed images viewed through said detail.

17. A reconfigurable control system, comprising:
a rear projection vehicle touch screen display including a projector and a display screen;
a plurality of physical control details mounted to said screen;
a sensing system to sense the position of said plurality of control details;
a computer to control said projector and determine from said sensed control detail positions the desired inputs to said control system; and
a means to reconfigure said control system from one set of displayed control functions to another.

18. A method for providing different user interface experiences using the same computer based display device, comprising the steps of:
providing a rear projection and computer based display and human interface having a screen and interaction surface on which projected information is displayed for a user to interact with;
providing sensing means to sense objects on or in front of said screen and interaction surface; providing an initial display screen and associated display software; and
removing said initial screen and substituting a second screen and associated display and sensing software, said second screen being physically different than said initial screen.

19. A method according to claim 18, wherein at least a portion of said second screen varies in shape from said initial screen.

20. A method according to claim 18, wherein at least a portion of said second screen varies in tactile relief from said initial screen.

21. A method according to claim 18, wherein at least one different physical control is mounted to said second screen than is present on said initial screen.
